(19) United States
(12) Patent Application Publication
(10) Pub. No.: US 2022/0221102 A1
(43) Pub. Date: Jul. 14, 2022

(54) GIMBAL CONTROL METHOD AND GIMBAL

(71) Applicant: SZ DJI TECHNOLOGY CO., LTD., Shenzhen (CN)

(72) Inventors: Jian YANG, Shenzhen (CN); Zhiyuan ZHANG, Shenzhen (CN); Xin DONG, Shenzhen (CN); Zhiyuan LOU, Shenzhen (CN); Ronghua LIN, Shenzhen (CN); Zhenhua XU, Shenzhen (CN)

(73) Assignee: SZ DJI TECHNOLOGY CO., LTD., Shenzhen (CN)

(21) Appl. No.: 17/692,663

(22) Filed: Mar. 11, 2022

Related U.S. Application Data
(63) Continuation of application No. PCT/CN2020/121321, filed on Oct. 15, 2020.

(51) Int. Cl. F16M 13/04; G03B 17/56; F16M 11/20

(52) U.S. Cl. CPC F16M 13/04; F16M 11/10; F16M 11/2071; G03B 17/561

(57) ABSTRACT

A handheld gimbal may include a body and a control assembly. The body may include one or more axis assemblies. Each of the one or more axis assemblies may include an arm and a motor for driving the arm to move around an axis. The control assembly may be configured to detect a change of a configuration of the handheld gimbal. The control assembly may also be configured to control at least one of the motors of the one or more axis assemblies to move the respective arm under a joint angle control mode.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to gimbal technologies and, more particularly, to a gimbal control method and a gimbal.

### BACKGROUND

A handheld or portable gimbal can be small and easy to carry. An imaging device such as a camcorder, a camera, or a smartphone can be mounted on the gimbal. The gimbal can stably maintain the imaging device at an attitude, improving the imaging quality. The handle of existing gimbals is generally designed as a fixed structure, which may cause difficulty for storing the gimbals.

### SUMMARY

In one aspect of the disclosure, a handheld gimbal includes a body including one or more axis assemblies, each of the one or more axis assemblies including an arm and a motor for driving the arm to move around an axis. The handle assembly includes a first part, a second part, and a rotating mechanism coupling the first part and the second part. The first part is coupled to the body, and the second part is configured to be separated from the body. One of the first part or the second part is rotatable relative to the other of the first part or the second part. When the handle assembly is in a first configuration, at least one portion of the first part is spaced apart from at least one portion of the second part. When the handle assembly is in a second configuration, the at least one portion of the first part are in contact with the at least one portion of the second part. The handheld gimbal also includes a communications part electrically coupling an electrical component of the first part to an electrical component of the second part such that the handheld gimbal is allowed to operate during a transition of the handle assembly from the first configuration to the second configuration or from the second configuration to the first configuration.

In some embodiments, the first part includes a motor of one of the one or more axis assemblies, and the second part includes a handle part.

In some embodiments, the handheld gimbal includes a detection mechanism configured to detect a change of a folding status of the handle assembly. The detection mechanism may include a sensor configured to detect the change of a folding status of the handle assembly. The sensor may include a photoelectric switch. The photoelectric switch may include a light transmitter and a light receiver. The light transmitter may be located in one of the first part or the second part, and the light receiver may be located in the other one of the first part and the second part. Alternatively, the sensor may include an ambient light sensor.

In some embodiments, the first part includes at least one first pin, and the second part includes at least one second pin. When the handle assembly is in a folded configuration, the at least one first pin is in contact with the at least one second pin. When the handle assembly is in a folded configuration, the at least one first pin is electrically connected to the at least second pin. In some embodiments, the at least one first pin may include a pin that is retractable. The at least one second pin may include a metal pin. The retractable pin may include a pogo pin. In some embodiments, the handheld gimbal includes at least one processor configured to monitor whether the at least one first pin and the at least one second pin are in contact. The at least one processor may be further configured to determine that the handle assembly is in the folded configuration in response to detecting a connection between the at least first pin and the at least second pin. The at least one processor may be further configured to determine that the handle assembly is in an unfolded configuration in response to detecting a disconnection between the at least one first pin and the at least one second pin. In some embodiments, monitoring whether the at least one first pin and the at least one second pin are in contact includes monitoring an electrical connection between the at least one first pin and the at least one second pin.

In some embodiments, the handheld gimbal includes another rotating mechanism coupling the body and the first part, and the first part may be rotatable relative to the body along an axis of the another rotating mechanism.

In some embodiments, the communications part includes a wire. The handle assembly may include a first electronic component, and the body may include a second electronic component that are electrically connected to the first electronic component via the wire. At least part of the wire may be covered by a protection film. The wire may be folded into a cavity of the second part when the handle assembly is in a folded configuration. At least one portion of the wire may be located outside of the handle assembly when the handle assembly is in the folded configuration. In some embodiments, at least one portion of the wire is retractable. The retractable portion of the wire winds around the axis of the rotating mechanism. In some embodiments, the first part includes a first pressing member for pressing a first portion of the wire that comes out of the first part, and the second part includes a second pressing member for pressing a second portion of the wire that comes out of the second part. In some embodiments, the second electronic component includes a battery configured to provide power to the first electronic component via the wire. Alternatively or additionally, the wire may include a serial cable configured to transmit a serial communication signal. Alternatively or additionally, the wire may be configured to transmit a signal generated by a hall sensor. Alternatively or additionally, the wire may be configured to transmit a control signal for controlling at least one of the one or more axis assemblies. In some embodiments, the one or more axis assemblies include a yaw axis assembly, and the wire is configured to transmit a control signal for controlling the motor of the yaw axis assembly. In some embodiments, the wire is configured to transmit a detection signal for detecting a change in a folding status of the handle assembly.

In some embodiments, the rotating mechanism includes a damping member. The rotating mechanism may include a damping part configured to slow down a rotation of an axle of the rotating mechanism. A damping force of the damping part exceeds a predetermined value. The rotating mechanism may include a front support configured to provide support to the rotating mechanism and limit a rotation of an axle of the rotating mechanism. In some embodiments, the second part includes a handle part, the handle part includes a cover, and the front support is fixed to the cover. The front support may be fixed to the cover via at least one of a screw or glue. The rotating mechanism may include one or more positioning parts configured to connect an axle of the rotating mechanism to a support base. The rotating mechanism may include a plurality of friction plates configured to provide a damping force to slow a rotation of an axle of the rotating mechanism. The rotating mechanism may include an axle configured to rotate along the axis of the rotating mechanism and a support configured to support the axle. A gap between the support and one end of the axle that connects the support may be minimal such that an axial rotation of the axle may be prevented during a lateral movement of the axle.

In some embodiments, the rotating mechanism includes a front gear and an axle support base configured to provide support to the front gear and connect the body and the rotating mechanism. The front gear may be fixed to the axle support base. The rotating mechanism further may include a back gear connected to the front gear. The front gear may include a first face gear having a plurality of cogs, and the back gear may include a second face gear having a plurality of cogs. The plurality of cogs of the first face gear may be configured to lock the plurality of cogs of the second face gear when the rotating mechanism is tightened, thereby decreasing a lateral movement of the axle of the rotating mechanism. The second part may include a handle part, the handle part may include a cover, and the back gear may be fixed to the cover.

In some embodiments, the rotating mechanism includes a knob configured to cause an axle of the rotating mechanism to rotate when the knob is turned. The rotating mechanism may include a knob axle connected to a front gear of the rotating mechanism. The knob axle may be connected to the front gear via threads in an end of the knob axle. The rotating mechanism may include a limiting mechanism configured to limit the knob to be turned within a predetermined range. The predetermined range may be 0 to 540 or 0 to 720. In some embodiments, the limiting mechanism includes an axle limiting plate and an axle limiting ring.

In some embodiments, the rotating mechanism further includes a knob axle limiting nut configured to limit or prevent a lateral movement of the axle of the rotating mechanism when the knob is turned. When the knob is turned to unlock the rotating mechanism, the knob axle limiting nut may rotate and cause the front gear to move along an axis of the axle of the rotating mechanism, thereby causing the front gear to separate from a back gear of the rotating mechanism.

In some embodiments, the rotating mechanism is configured to rotate the first part or the second part along two or more axes. The rotating mechanism may include a shaft mechanism configured to provide a first torsion in a first range of a rotation of the shaft mechanism and a second torsion in a second range of the rotation of the shaft mechanism. The first torsion may be different from the second torsion. Alternatively or additionally, the rotating mechanism may include a fixed-point rotating shaft. Alternatively or additionally, the rotating mechanism may include a first stable position and a second stable position. When the rotating mechanism rotates beyond a predetermined position between the first stable position and the second stable position, the rotating mechanism may automatically rotate to the first stable position or the second position.

In some embodiments, the handle assembly includes a locking mechanism configured to lock a position of the second part relative to the first part. The locking mechanism may include a knob that, when the knob is turned, causes the locking mechanism to lock or unlock the position of the second part relative to the first part. The locking mechanism may include a first gear on the first part and a second gear on the second part. The first gear may include a plurality of first cogs, and the second gear may include a plurality of second cogs. The plurality of first cogs are configured to lock the plurality of second cogs when the locking mechanism is tightened, thereby locking the position of the second part relative to the first part. In some embodiments, the locking mechanism includes an eccentric cam lock. Alternatively, the locking mechanism may include a clamp lock. Alternatively, the locking mechanism may include a first object and a second object. The first object may include an internal screw thread configured to receive an external screw thread of the second object, and the first object or the second object may be fixed to a shaft of the motor of at least one of the one or more axis assemblies.

In some embodiments, the handle assembly includes a first magnetic plate in the first part and a second magnetic plate in the second part such that, when the handle assembly is in a folded configuration, the first magnetic plate is in contact with the second magnetic plate. Alternatively or additionally, the first part of the handle assembly may include at least one plunger, and a part of the at least one plunger may be retracted when the handle assembly may be in the folded configuration.

In some embodiments, the handle assembly includes a sensor configured to detect a change of a folding status of the handle assembly. The sensor may include a photoelectric sensor configured to detect a change in a light intensity when the handle assembly changes from a folded configuration to an unfolded configuration or from an unfolded configuration to the folded configuration. The handheld gimbal may also include an indicator generating a signal indicating the detected change in the folding status of the handle assembly. The indicator may further include at least one of a light configured to generate a light signal or a speaker configured to generate a sound signal.

In some embodiments, the handheld gimbal includes a platform for supporting the payload. The handheld gimbal may be operable to move at least one of the one or more axis assemblies to an underslung mode with the platform being below the handle assembly when the handle assembly is in an unfolded configuration. The payload may be operable to capture an image in a portrait mode. In some embodiments, when the second part is subject to a supporting force in the underslung mode, at least a portion of the handheld gimbal may be configured to move to a particular position such that a center of gravity of the handheld gimbal is aligned with a vertical component of the supporting force.

In some embodiments, the handheld gimbal has a first storage mode in which the second part is in a same plane as the arms of the one or more axis assemblies. Alternatively or additionally, the handheld gimbal may have a second storage mode in which the second part is in a different plane than the arms of the one or more axis assemblies. In some embodiments, when the handheld gimbal is in the second storage mode, a plane of the second part is perpendicular to a plane of the arms of the one or more assemblies.

In some embodiments, the handle assembly includes a cover including one or more receiving parts for receiving an accessory attached to the cover.

In another aspect of the disclosure, a handheld gimbal includes a body. The body includes one or more axis assemblies and a platform for supporting a payload, each of the one or more axis assemblies including an arm and a motor for driving the arm to move around an axis. The handheld gimbal also includes a handle assembly. The handle assembly includes a first part, a second part, and a rotating mechanism coupling the first part and the second part. The first part is coupled to the body, and the second part is configured to be separated from the body. The handle assembly includes a folded status and an unfolded status. The handle assembly also includes a communications part electrically coupling an electrical component of the first part to an electrical component of the second part. The handheld gimbal further includes at least one processor configured to receive, via the communications part, a signal indicating a change in a folding status of the handle assembly from the folded status to the unfolded status or from the unfolded status to the folded status. The at least one processor is also configured to, in response to the received signal, control the one or more axis assemblies to move the payload to a target attitude/position.

In another aspect of the disclosure, a method for controlling a handheld gimbal that comprises a handle assembly includes detecting/determining whether the handle assembly is in a first configuration. The handheld gimbal includes a platform supporting a payload and one or more axis assemblies. The one or more axis assemblies includes a first axis assembly. The first axis assembly includes a first arm and a first motor configured to move the first arm around a first axis. The handle assembly is capable of changing between the first configuration and a second configuration different from the first configuration. The method further includes, in response to detecting/determining the handle assembly being in the first configuration, controlling the first axis assembly to move to a first target position under a joint angle control mode for controlling a joint angle of the first motor.

In some embodiments, the handheld gimbal further includes a second axis assembly including a second arm and a second motor configured to move the second arm around a second axis. The method further includes controlling the platform to move to a target attitude under an attitude control mode for controlling the second axis assembly based on a north-east-down (NED) coordinate system. In some embodiments, the handheld gimbal further includes a third axis assembly including a third arm and a third motor configured to move the third arm around a third axis. The method further includes controlling the second axis assembly and the third axis assembly under the attitude control mode based on the NED coordinate system. In some embodiments, the first axis is a yaw axis, the second axis is one of a pitch axis or a roll axis, and the third axis is the other of a roll axis or a pitch axis.

In some embodiments, controlling the second axis assembly under the attitude control mode includes determining a target attitude of the platform and controlling the second axis assembly and the third axis assembly to move such that the target attitude of the platform is reached.

In some embodiments, controlling the second axis assembly and the third axis assembly includes controlling the second motor and/or the third motor to rotate such that a target second attitude angle is reached, and/or controlling the second motor and/or the third motor to rotate such that a target third attitude angle is reached. In some embodiments, the method may further includes determining a target first joint angle of the first motor, and determining a target second joint angle of the second motor, and determining a target third joint angle of the third motor. In some embodiments, the first axis is one of a roll axis, or a yaw axis or a pitch axis.

In some embodiments, determining the target first joint angle or the target second joint angle or the target third joint angle includes: obtaining a target attitude of the platform at a starting position; obtaining an attitude of the handle assembly; and determining the target attitude of the platform relative to the handle assembly. In some embodiments, determining the target attitude of the platform includes determining the target first joint angle or the target second joint angle or the target third joint angle at predetermined intervals from a starting point.

In some embodiments, determining the target first joint angle or the target second joint angle or the target third joint angle at predetermined intervals includes: obtaining a first joint angle or a second joint angle or a third joint angle at the starting point.

In some embodiments, determining the target attitude of the platform includes: determining a current target attitude of the platform; and determining the current target attitude of the platform includes: determining a current target first joint angle or a current target second joint angle or a current target third joint angle.

In some embodiments, the handheld gimbal further includes a second axis assembly including a second arm and a second motor configured to move the second arm around a second axis; and a third axis assembly including a third arm and a third motor configured to move the third arm around a third axis.

In some embodiments, the method further includes: in response to determining the handle assembly being in the first configuration: controlling the second axis assembly to move to a second target position under the joint angle control mode for controlling a joint angle of the second motor; and controlling the a platform to move to a target attitude under an attitude control mode.

In some embodiments, the handheld gimbal further includes: a second axis assembly including a second arm and a second motor configured to move the second arm around a second axis; and a third axis assembly including a third arm and a third motor configured to move the third arm around a third axis. The method further includes: in response to determining the handle assembly being in the first configuration: controlling the second axis assembly to move to a second target position under the joint angle control mode for controlling a joint angle of the second motor; and controlling the third axis assembly to move to a third target position under the joint angle control mode for controlling a joint angle of the third motor.

In some embodiments, controlling the first axis assembly includes: determining a current first joint angle of the first motor; determining a first target joint angle of the first motor; and controlling the first motor such that the first target joint angle of the first motor is reached. In some embodiments, controlling the first motor further includes: when the first target joint angle is in a predetermined range, controlling the first axis assembly to move to a target position such that the first target joint angle is reached. In some embodiments, controlling the first motor further includes: when the first target joint angle is not in a predetermined range, controlling the first axis assembly to move to a predetermined reset position; and after moving the first axis assembly to the predetermined reset position, controlling the first axis assembly to move to a target position such that the first target joint angle is reached. In some embodiments, the method includes: determining an updated current first joint angle of the first motor when the first axis assembly moves to a new position; determining that a difference between the updated current first joint angle and the target first joint angle is equal to or less than a threshold; and confirming that a switch from a first folding mode to a second folding mode is completed.

In some embodiments, the handheld gimbal includes an angle sensor configured to measure the first joint angle. The angle sensor includes a linear hall sensor. The handheld gimbal includes one or more gyroscopes configured to measure a body attitude angle speed under payload coordinate system. In some embodiments, the handheld gimbal further includes one or more integrators configured to determine a second attitude angle under the NED coordinate system.

In some embodiments, the handle assembly includes a first part, a second part, and a rotating mechanism coupling the first part and the second part. The first part is coupled to a body of the handheld gimbal, and the second part is separated from the body and rotatable relative to the first part along an axis of the first rotating mechanism. The first part includes at least one first pin, and the second part includes at least one second pin. When the handle assembly is in a folded configuration, the at least first pin is in contact with the at least one second pin. Detecting the change in the folding status of the handle assembly includes detecting a change in a contact status between the at least one first pin and the at least one second pin. In some embodiments, when the handle assembly is in the folded configuration, the at least one first pin is electrically connected to the at least one second pin. Detecting the change in the folding status of the handle assembly includes detecting an electrical connection or disconnection between the at least one first pin and the at least one second pin.

In another aspect of the disclosure, a handheld gimbal includes a gimbal assembly configured to support a payload and rotate the payload with respect to one or more axes. The handheld gimbal also includes a handle assembly operably coupled to the gimbal assembly. The handle assembly includes a first part coupled to the gimbal assembly, and a second part movable with respect to the first part. The first part has a first surface, and the second part has a second surface. The handle assembly has a first configuration in which the first surface and the second surface form a first angle, and the handle assembly has a second configuration in which the first surface and the second surface form a second angle. The first angle is smaller than the second angle. The gimbal assembly is configured to be operational when the handle assembly is in the first configuration and when the handle assembly is in the second configuration.

In some embodiments, the handle assembly includes a sensor configured to measure the first angle and the second angle. In some embodiments, the first angle is equal to 0 degrees. The second angle is greater than 0 degrees. In some embodiments, the second angle is equal to or less than 180 degrees.

In some embodiments, the handle assembly includes a rotating mechanism coupling the first part and the second part.

In some embodiments, the handle assembly includes an input device configured to receive an input. When the handle assembly is in the first configuration, the gimbal assembly is configured to rotate the payload in response to a first input. When the handle assembly is in the second configuration, the gimbal assembly is configured to rotate the payload in response to a second input. In some embodiments, the gimbal assembly is configured to be operational during a transition of the handle assembly from the first configuration to the second configuration.

In another aspect of the disclosure, a handheld gimbal includes a gimbal assembly configured to support a payload and rotate the payload with respect to one or more axes. The handheld gimbal also includes a handle assembly operably coupled to the gimbal assembly, which includes a first part coupled to the gimbal assembly and a second part movable with respect to the first part. The handle assembly has a first configuration and a second configuration. In the first configuration, the first part is at a first position relative to the second part. In the second configuration, the first part is at a second position relative to the second part. The first position being different from the second position. The handheld gimbal also includes a control assembly configured to control the gimbal assembly according to a first control mechanism when the handle assembly is in the first configuration and to control the gimbal assembly according to a second control mechanism when the handle assembly is in the second configuration.

In some embodiments, the control assembly is configured to detect a change from the first configuration to the second configuration or from the second configuration to the first configuration. In some embodiments, in the first configuration, at least one portion of the first part overlaps with at least one portion of the second part. In the second configuration, at least one portion of the first part is spaced apart from at least one portion of the second part. The control assembly is configured to control the gimbal assembly during a transition of the handle assembly from the first configuration to the second configuration or from the second configuration to the first configuration.

In some embodiments, the control assembly is configured to control the gimbal assembly according to a third control mechanism during the transition of the handle assembly from the first configuration to the second configuration or from the second configuration to the first configuration. In some embodiments, the first control mechanism includes a first algorithm for controlling the gimbal assembly, and the second control mechanism includes a second algorithm for controlling the gimbal assembly. The first algorithm is different from the second algorithm. In some embodiments, the handle assembly includes an input device configured to receive an input, and the gimbal assembly is configured to rotate the payload in response to the received input.

In another aspect of the disclosure, a method for controlling a handheld gimbal includes providing a gimbal assembly configured to support a payload and rotate the payload with respect to one or more axes. The method also includes providing a handle assembly operably connected to the gimbal assembly. The handle assembly includes: a first part coupled to the gimbal assembly and a second part movable with respect to the first part. The first part has a first surface, and the second part has a second surface. The handle assembly has a first configuration in which the first surface and the second surface form a first angle, and the handle assembly has a second configuration in which the first surface and the second surface form a second angle. The first angle being smaller than the second angle. The gimbal assembly is configured to be operational when the handle assembly is in the first configuration and when the handle assembly is in the second configuration.

In another aspect of the disclosure, a method for controlling a handheld gimbal includes providing a gimbal assembly configured to support a payload and rotate the payload with respect to one or more axes. The method also includes providing a handle assembly operably coupled to the gimbal assembly. The handle assembly includes a first part connected to the gimbal assembly and a second part movable with respect to the first part. The handle assembly has a first configuration and a second configuration. In the first configuration, the first part is at a first position relative to the second part. In the second configuration, the first part is at a second position relative to the second part. The first position is different from the second position. The method also includes controlling the gimbal assembly according to a first control mechanism when the handle assembly is in the first configuration and to control the gimbal assembly according to a second control mechanism when the handle assembly is in the second configuration.

In another aspect of the disclosure, a gimbal includes a gimbal assembly configured to support a payload and rotate the payload with respect to one or more axes. The gimbal also includes a foldable assembly operably coupled to the gimbal assembly. The foldable assembly includes a first part coupled to the gimbal assembly and a second part movable with respect to the first part. The foldable assembly has a first configuration in which the first part and the second part form a first angle, and the foldable assembly has a second configuration in which the first part and the second part form a second angle. The first angle is smaller than the second angle. The gimbal assembly is configured to be operational when the foldable assembly is in the first configuration and when the foldable assembly is in the second configuration.

In another aspect of the disclosure, a method for controlling a gimbal includes providing a gimbal assembly configured to support a payload and rotate the payload with respect to one or more axes. The method also includes providing a foldable assembly coupled to the gimbal assembly. The foldable assembly includes a first part coupled to the gimbal assembly and a second part movable with respect to the first part. The foldable assembly has a first configuration in which the first part and the second part form a first angle. The foldable assembly has a second configuration in which the first part and the second part form a second angle. The first angle is smaller than the second angle. The gimbal assembly is configured to be operational when the foldable assembly is in the first configuration and when the foldable assembly is in the second configuration.

In another aspect of the disclosure, a gimbal includes a gimbal assembly configured to support a payload and rotate the payload with respect to one or more axes. The gimbal also includes a foldable assembly operably connected to the gimbal assembly, includes a first part coupled to the gimbal assembly, and a second part movable with respect to the first part between a first configuration of the foldable assembly and a second configuration of the foldable assembly. The gimbal also includes a control assembly configured to control the gimbal assembly according to a first control mechanism when the foldable assembly is in the first configuration and to control the gimbal assembly according to a second control mechanism when the foldable assembly is in the second configuration.

In another aspect of the disclosure, a method for controlling a gimbal includes providing a gimbal assembly configured to support a payload and rotate the payload with respect to one or more axes. The method also includes providing a foldable assembly operably connected to the gimbal assembly. The foldable assembly includes a first part coupled to the gimbal assembly and a second part movable with respect to the first part between a first configuration of the foldable assembly and a second configuration of the foldable assembly. The method also includes controlling the gimbal assembly according to a first control mechanism when the foldable assembly is in the first configuration and to control the gimbal assembly according to a second control mechanism when the foldable assembly is in the second configuration.

In another aspect of the disclosure, a handheld gimbal includes a body including one or more axis assemblies. Each of the one or more axis assemblies includes an arm and a motor for driving the arm to move around an axis. The handheld also includes a control assembly configured to detect a configuration of the handheld gimbal, and in response to the detected configuration, control at least one of the motors of the one or more axis assemblies to move the respective arm under a joint angle control mode.

In another aspect of the disclosure, a method for controlling a handheld gimbal includes providing a body includes one or more axis assemblies. Each of the one or more axis assemblies includes an arm and a motor for driving the arm to move around an axis. The method also includes detecting a configuration of the handheld gimbal, and in response to the detected configuration of the handheld gimbal, controlling at least one of the motors of the one or more axis assemblies to move the respective arm under a joint angle control mode.

In another aspect of the disclosure, a method for controlling a handheld gimbal is provided. The handheld gimbal may comprise a foldable assembly and a platform supporting a payload. The handheld gimbal may also comprise one or more axis assemblies, and the one or more axis assemblies comprise a first axis assembly; and the first axis assembly comprises a first arm and a first motor configured to move the first arm around a first axis. The method may include detecting a change in a folding status of the foldable assembly, and in response to the detected change in the folding status, controlling the first axis assembly to move to a first target position under a joint angle control mode for controlling a joint angle of the first motor.

In another aspect of the disclosure, there is provided a non-transitory computer-readable medium storing instructions that, when executed, causes a computing device to perform a method according to the above mentioned

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic illustration of an exemplary handheld gimbal having a foldable handle in a folded configuration, consistent with disclosed embodiments.

FIG. 2 is a schematic illustration of an exemplary handheld gimbal having a foldable handle in an unfolded configuration, consistent with disclosed embodiments.

FIG. 3 is a schematic illustration of an exemplary handheld gimbal having a foldable handle in another unfolded configuration, consistent with disclosed embodiments.

FIGS. 4A and 4B are schematic illustrations of two storage modes of an exemplary handheld gimbal having a foldable handle in an unfolded configuration, consistent with disclosed embodiments.

FIG. 5 of a perspective view of an exemplary handheld gimbal having a foldable handle in an unfolded configuration, consistent with disclosed embodiments.

FIG. 6A is an exploded view of an exemplary rotating mechanism, consistent with disclosed embodiments.

FIG. 6B is a front view of an exemplary rotating mechanism, consistent with disclosed embodiments.

FIGS. 6C and 6D are side views of an exemplary front gear and an exemplary back gear, consistent with disclosed embodiments.

FIG. 7 is a block diagram of an exemplary handheld gimbal, consistent with disclosed embodiments.

FIG. 8 is a flow chart of an exemplary process for controlling a handheld gimbal, consistent with disclosed embodiments.

FIG. 9 illustrates an equation for determining a target joint angle, consistent with disclosed embodiments.

### DETAILED DESCRIPTION

The following detailed description refers to the accompanying drawings. Wherever possible, the same reference numbers refer to the same or similar parts. While several illustrative embodiments are described herein, modifications, adaptations and other implementations are possible. For example, substitutions, additions or modifications may be made to the components illustrated in the drawings. Accordingly, the following detailed description is not limited to the disclosed embodiments and examples. Instead, the proper scope is defined by the appended claims.

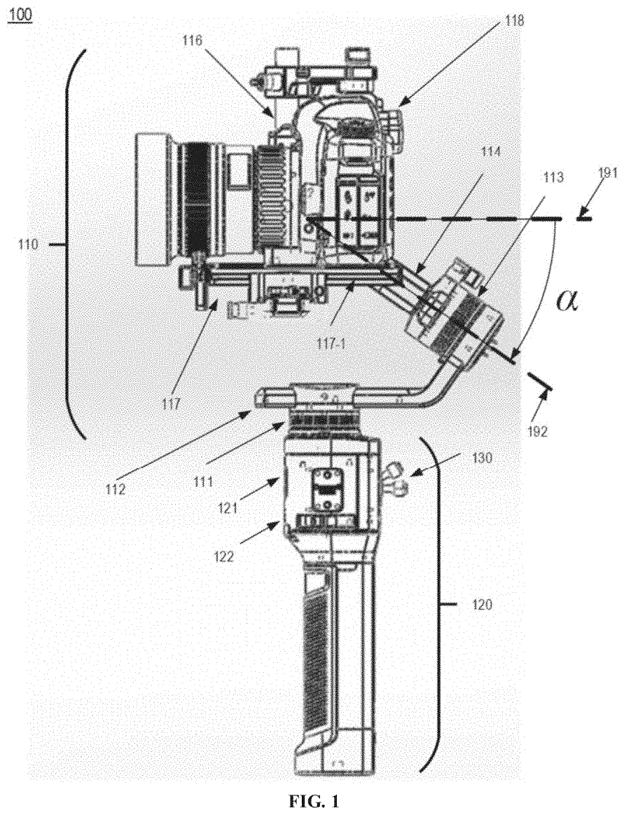

FIG. 1 is a schematic illustration of an exemplary handheld gimbal 100 consistent with disclosed embodiments. As illustrated in FIG. 1, handheld gimbal 100 includes a body (also referred herein as a gimbal assembly) 110, a handle assembly (also referred herein as a foldable assembly) 120 (for example in a folded configuration), and an input device 130. While the drawings and relevant descriptions thereof are directed to the configuration as a folded configuration in FIG. 1, one skilled in the art would understand that the configuration in FIG. 1 disclosed herein can also be called an unfolded configuration or other configuration based on different user habits.

While the drawings and relevant descriptions thereof are directed to handheld gimbals, one skilled in the art would understand that the designs and configuration disclosed herein can also implemented in other types of gimbals (e.g., non-portable or regular-sized gimbals) without undue experimentation.

Body 110 includes one or more axis assemblies configured to move a payload (e.g., a photographic device 118) to a particular attitude/position having a particular orientation. For example, body 110 may include a pitch axis assembly, a roll axis assembly, and a yaw axis assembly. The pitch axis assembly includes a pitch axis arm 116 and a pitch axis motor 115 configured to drive pitch axis arm 116. The roll axis assembly includes a roll axis arm 114 and a roll axis motor 113 configured to drive roll axis arm 114. The yaw axis assembly includes a yaw axis arm 112 and a yaw axis motor 111 configured to drive yaw axis arm 112.

A payload may include a camera, a camcorder, a mobile phone, a tablet PC, a laptop, a sensor, a Light Detection and Ranging (LiDAR) scanner, a laser meter, or the like, or a combination thereof.

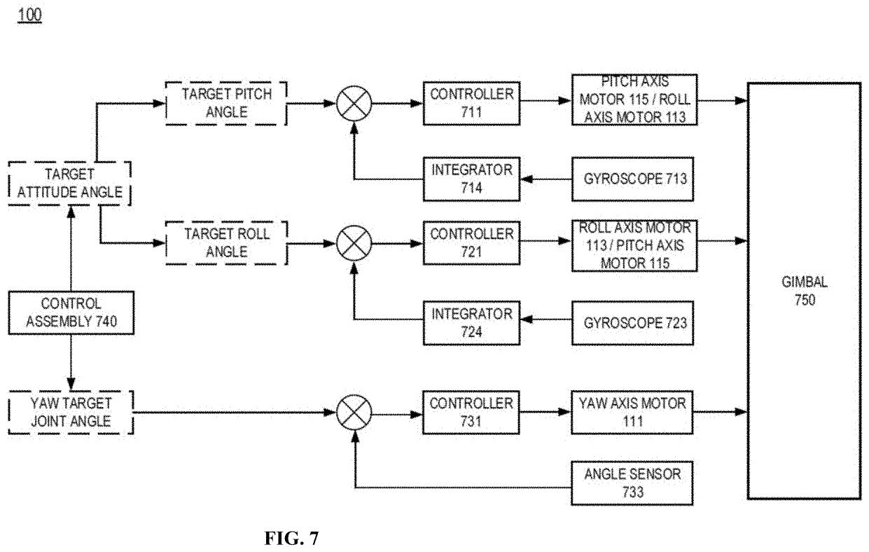

Body 110 also includes a fastening assembly 117 directly connected to one side of the pitch axis arm 116 and configured to fix photographic device 118 to body 110. When in use, photographic device 118 may be placed on a platform of fastening assembly 117 and fastened thereto. In some embodiments, an inertial measurement unit (IMU) may be disposed inside fastening assembly 117 to measure the attitude and acceleration of photographic device 118. The IMU may include at least one of an accelerometer and a gyroscope. The gimbal 100 further comprises a control assembly 740 as shown in FIG. 7. The IMU may be configured to measure the attitude and acceleration of photographic device 118 and transmit the measured attitude and acceleration (and/or the data relating to the measured attitude and acceleration) to control assembly 740 and/or other components of handheld gimbal 100 for processing. The IMU may be configured to measure the attitude and acceleration continuously, intermittently, or in real-time. The IMU may be configured to transmit the data relating to the measured attitude and acceleration to the at least one processor and/or other components of handheld gimbal 100 continuously, intermittently, or in real-time.

In some embodiments, an angle sensor (not shown) may be disposed at the corresponding motor of the one or more axis assemblies such as the yaw axis motor 111, the roll axis motor 113 and the pitch axis motor 115. The angle sensor may include at least one of a Hall sensor and an odometer. In some embodiments, an angle sensor (not shown) may include an angle sensor configured to measure the joint angle of the corresponding motor of the one or more axis assemblies such as the yaw axis motor 111, the roll axis motor 113 and the pitch axis motor 115. The angle sensor may be configured to measure the joint angle of an axis motor and transmit the measured joint angle (and/or the data relating to the measured joint angle) to control assembly 740 and/or other components of handheld gimbal 100 for processing. The angle sensor may be configured to measure the angle continuously, intermittently, or in real-time. The angle sensor may be configured to transmit the data relating to the measured joint angle to the at least one processor and/or other components of handheld gimbal 100 continuously, intermittently, or in real-time.

In some embodiments, an angle sensor may include an angle sensor configured to measure the angle between the axle of roll axis motor 113 and a horizontal plane (or a plane crossing platform 117-1), which is referred herein to as the a angle. For example, as illustrated in FIG. 1, an angle sensor (not shown) may be configured to measure an angle α between the axle of roll axis motor 113 (line 192) and the horizontal plane (plane 191) (or a plane crossing platform 117-1).

In some embodiments, an angle sensor (e.g., a linear Hall sensor and an odometer) may be disposed on the joint between roll axis arm 114 and fastening assembly 117. The angle sensor may be configured to measure the a angle and transmit the measured a angle (and/or the data relating to the measured joint angle) to control assembly 740 and/or other components of handheld gimbal 100 for processing. The angle sensor may be configured to measure the angle continuously, intermittently, or in real-time. The angle sensor may be configured to transmit the data relating to the measured a angle to the at least one processor and/or other components of handheld gimbal 100 continuously, intermittently, or in real-time.

It should be understood that body 110 may include only one or two axis assemblies. Although the yaw axis assembly is connected to one end of the roll axis assembly and the pitch axis assembly is connected to the other end of the roll axis assembly, as shown in FIG. 1, the arrangement is not intended to limit the present disclosure. The yaw axis assembly, the roll axis assembly, and the pitch axis assembly may be arranged differently.

It should be understood that body 110 may include only one or two axis assemblies. Although the yaw axis assembly is connected to one end of the roll axis assembly and the pitch axis assembly is connected to the other end of the roll axis assembly as shown in FIG. 1, the arrangement is not intended to limit the present disclosure. The yaw axis assembly, the roll axis assembly, and the pitch axis assembly may be arranged differently from the exemplary configuration illustrated in FIG. 1. For example, the arrangement may include a yaw-pitch-roll axis arrangement configuration.

Input device 130 is configured to receive input from the user to operate handheld gimbal 100. For example, input device 130 may include one or more control joysticks and/or one or more buttons configured to receive user input for moving photographic device 118 or controlling the movement of the motor and the arm of the one or more axis assemblies. Alternatively or additionally, input device 130 may include one or more microphones configured to receive sound signals for controlling handheld gimbal 100. Input device 130 is also configured to transmit the received input to a control assembly (e.g., control assembly 740 illustrated in FIG. 7) of handheld gimbal 100 for processing. In some embodiments, input device 130 may include another input interface, such as a display screen (e.g. touchscreen), for the user to configure one speed parameter for moving photographic device 118 or other parameters for controlling the movement of the motor and the arm of the one or more axis assemblies. In some embodiments, the handheld gimbal 100 may comprises a input mechanism configured to receive the input signal/instruction via the movement of a user such as the movement of a user's finger or a user's palm or a user's arm, or via a user's body attitude, or via a user's operation to the gimbal, such as when the user moves the gimbal downwardly, the gimbal is configured to change from a first configuration to a second configuration.

Handheld gimbal 100 includes control assembly 740 (not shown) configured to control handheld gimbal 100. For example, control assembly 740 may receive data relating to user input received from input device 130. Control assembly 740 can then control handheld gimbal 100 (e.g., moving photographic device 118 via one or more axis assemblies) based on the user input. As another example, control assembly 740 may detect a change in the folding configuration of handle assembly 120 (e.g., from being folded to unfolded, or from being unfolded to folded, or from being at a first angle to a second angle). The at least one processor may also receive data relating to the current attitude from the IMU or the current joint angle or a angle from the angle sensor and determine a target joint angle of at least one axis motor. Control assembly 740 may further control the one or more assemblies to move to the target joint angle(s) such that the photographic device 118 (and/or fastening assembly 117) is capable to move to a target attitude/position. In some embodiments, control assembly 740 may be disposed in handle assembly 120 (e.g., second part 122).

In some embodiments, control assembly 740 includes at least one processor configured to perform the functions of control assembly 740 disclosed herein. In some embodiments, the at least one processor includes a central processing unit (CPU). The at least one processor may include another generic processor, a digital signal processor (DSP), an application specific integrated circuit (ASIC), a field programmable gate arrays (FPGA), or another programmable logic device, a discrete gate or transistor logic device, or a discrete hardware component, etc. The generic processor may include a microprocessor or any conventional processor. In some embodiments, the at least one processor may communicate with a terminal. The terminal may include a personal computer, a mobile device, a tablet PC, or the like, or a combination thereof. The user may configure the parameters for controlling handheld gimbal 100 through an APP installed on the terminal, which transmit data to the at least one processor. The at least one processor can then control handheld gimbal 100 based on the data received from the terminal.

In some embodiments, handle assembly 120 further includes a battery (not shown), to supply power to handheld gimbal 100.

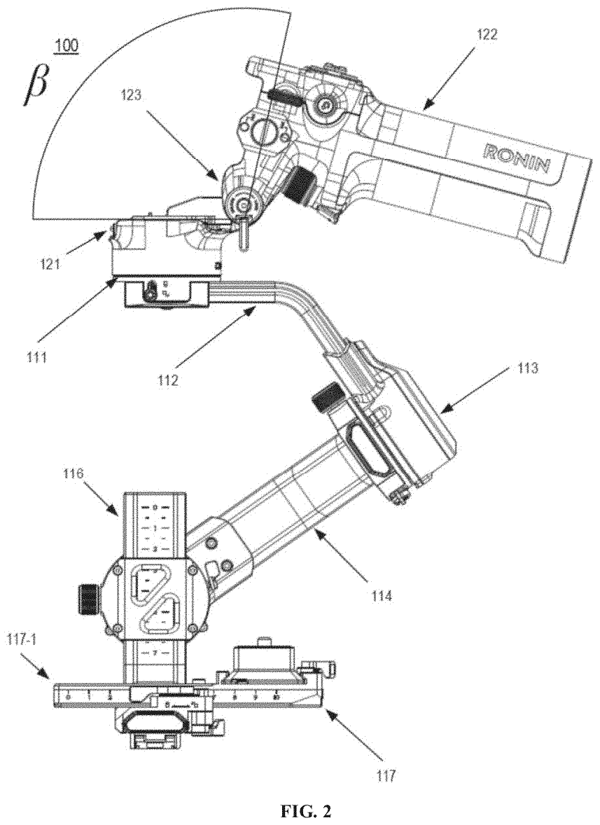

FIG. 2 is a schematic illustration of handheld gimbal 100 with handle assembly 120 in an unfolded configuration. While the drawings and relevant descriptions thereof are directed to the configuration as an unfolded configuration in FIG. 2, one skilled in the art would understand that the configuration in FIG. 2 disclosed herein can be also called a folded configuration or other configuration based on different user habits.

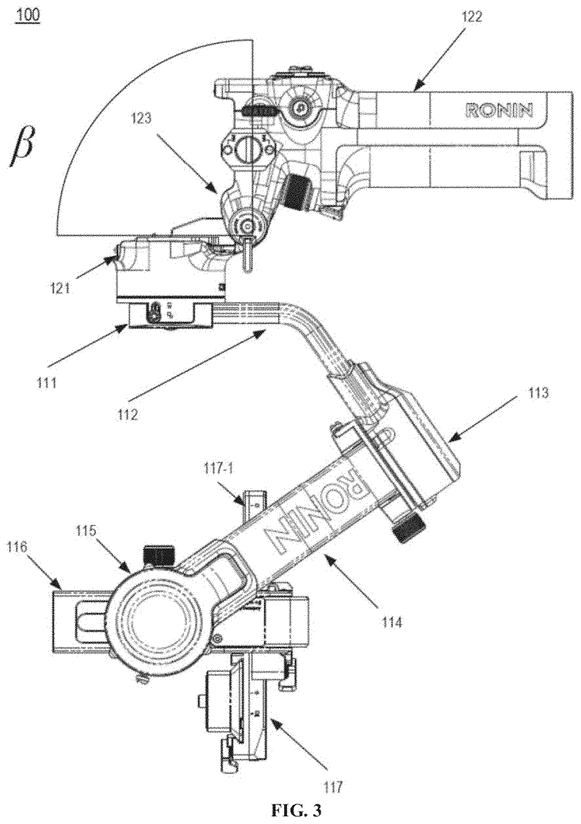

In some embodiments, for example, the user may unfold handle assembly 120 by unlocking a locking mechanism and rotating second part 122 along the axis of rotating mechanism 123. The user may also lock the locking mechanism to lock the position of second part 122 in relation to first part 121. Photographic device 118 may be placed and secured on a plane crossing platform 117-1, of platform assembly, in an underslung mode as shown in FIG. 2 and FIG. 3. In the underslung mode, platform 117-1 is below the handle assembly. This underslung mode may be used for application scenarios such as low angle shots (e.g., for low to ground scenes). The user may adjust the rotation angle of rotating mechanism 123 such that the direction of force applied by a holding hand of the user can be kept consistent with a direction of a center of gravity of the entire handheld gimbal 100, to minimize the force to handheld gimbal 100 and the difficulty in use. For example, when second part 122 is subject to a supporting force in the underslung mode, at least a portion of handheld gimbal 100 is configured to move to a particular attitude/position such that a center of gravity of handheld gimbal 100 is aligned with a vertical component of the supporting force.

In some embodiments, photographic device 118 is operable to capture an image in a portrait mode when handheld gimbal 100 is. In some embodiments, the portrait mode may be used for application scenarios such as the camera is disposed vertically, as shown in FIG. 3.

In some embodiments, first part 121 includes a motor of one of the one or more axis assemblies (e.g., a yaw axis motor). Second part 122 may include a handle part for the user to grab or hold handheld gimbal 100. While the drawings and relevant descriptions thereof are directed to that the first part 121 includes a yaw axis motor, one skilled in the art would understand that the first part 121 may include an axis assembly (including a motor and an arm) or other components such as the input device 130 or output device (not shown, e.g. display screen).

In some embodiments, additional or alternative to a manual change of a configuration to another configuration by the user, the user may interact with input device 130 or the handle assembly 120 to enter an input for change a first configuration (e.g., the folded configuration) to a second configuration (e.g., an unfolded configuration). For example, the user may push a button or click a touch screen for unfolding (or folding) handle assembly 120. For example, when the user moves the gimbal downwardly, the gimbal is configured to change from a first configuration (e.g. folded/unfolded) to a second configuration (e.g. unfolded/folded). In response to the input signal, the handle assembly may unfold (or fold) itself. For example, an additional motor may be provided at the rotating mechanism 123 such that the first part 121 is capable to rotate with respect to the second part 122 itself.

In some embodiments, handheld gimbal 100 may include a communications part electrically coupling an electrical component of the first part to an electrical component of the second part such that handheld gimbal 100 is able to operate during a transition of the handle assembly from a first configuration (e.g., the folded configuration) to a second configuration (e.g., an unfolded configuration) or from the second configuration to the first configuration.

FIG. 3 is a schematic illustration of handheld gimbal 100 with handle assembly 120 in another unfolded configuration. For example, the user may unfold handle assembly 120 by unlocking a locking mechanism and rotating second part 122 along the axis of rotating mechanism 123. The user may also lock the locking mechanism to lock the position of second part 122 in relation to first part 121. In some embodiments, the locking mechanism includes a first gear on the first part and a second gear on the second part. The first gear includes a plurality of first cogs, and the second gear includes a plurality of second cogs. The plurality of first cogs are configured to lock the plurality of second cogs when the locking mechanism is tightened, thereby locking the position of the second part relative to the first part. In some embodiments, the locking mechanism includes an eccentric cam lock. Alternatively, the locking mechanism includes a clamp lock. Alternatively, the locking mechanism includes a first object and a second object. The first object has an internal screw thread configured to receive an external screw thread of the second object. The first object or the second object is fixed to a shaft of the motor (e.g., a yaw axis motor) of at least one of the one or more axis assemblies.

Photographic device 118 may be placed and secured on plane crossing platform 117-1. Like the mode illustrated in FIG. 2, this underslung mode may also be used for application scenarios such as low angle shots (e.g., for low to ground scenes), but with photographic device 118 in the portrait mode.

In some embodiments, handle assembly 120 may include two or more configurations. For example, handle assembly 120 may include a first configuration in which handle assembly is folded (as illustrated in FIG. 1, or called unfolded in another aspect of view). Handle assembly 120 may also include a second configuration different from the first configuration. For example, in the second configuration, at least one portion of first part 121 is spaced apart from at least one portion of second part 122 (as illustrated in FIG. 2). In some embodiments, handle assembly 120 may include a third configuration different from the first and second configurations. For example, in the third configuration, at least one portion of first part 121 is spaced apart from at least one portion of second part 122 by a narrower space (as illustrated in FIG. 3), compared with the second configuration.

The first part and the second part may form an angle. The angle formed by the first part and the second part in a first configuration is different from that in a second configuration. Handheld gimbal 100 is configured to be operational when the handle assembly is in the first configuration and when the handle assembly is in the second configuration. In some embodiments, the angle formed by the first part and the second part includes an angle β formed by (or between) a surface of the first part of handle assembly 120 (also referred herein as to the first surface) with a surface of the second part of handle assembly 120 (also referred herein as the second surface) as shown in FIG. 2 and FIG. 3. The angle β between the first surface and the second surface may change in different configurations of handle assembly 120. For example, when handle assembly 120 is in the first configuration (e.g., in the folded configuration), the angle β between the first surface and the second surface is equal to 0 degrees (i.e., at least one portion of the first surface overlaps with at least one portion of the second surface). When handle assembly 120 is in a second configuration (e.g., in an unfolded configuration illustrated in FIG. 2), the angle between the first surface and the second surface is be greater than 0 degrees. As another example, when handle assembly 120 is in a third configuration (e.g., in an unfolded configuration illustrated in FIG. 3), the angle between the first surface and the second surface is greater than 0 degrees, but smaller than the angle in the second configuration illustrated in FIG. 2. In some embodiments, the angle between the first surface and the second surface may be in a range of 0 to 180 degrees. In some embodiments, handle assembly 120 may include a sensor configured to measure the angle between the first surface and the second surface. Body 110 may be configured to be operational when handle assembly 120 is in the first configuration and when handle assembly 120 is in the second configuration (and/or in the third configuration). For example, when the handle assembly is in the first configuration, the gimbal assembly is configured to rotate the payload in response to a first input received via input device 130. When the handle assembly is in the second configuration, the gimbal assembly is configured to rotate the payload in response to a second input received via input device 130.

In some embodiments, the angle formed by the first part and the second part includes an angle formed by (or between) a line/axis of the first part of handle assembly 120 with a surface of the second part of handle assembly 120. The angle between the line/axis of the first part and the surface of the second part may change in different configurations of handle assembly 120.

In some other embodiments, the angle formed by the first part and the second part includes an angle formed by (or between) a line/axis of the first part of handle assembly 120 with another line/axis of the second part of handle assembly 120. The angle between the line/axis of the first part and another line/axis of the second part may change in different configurations of handle assembly 120.

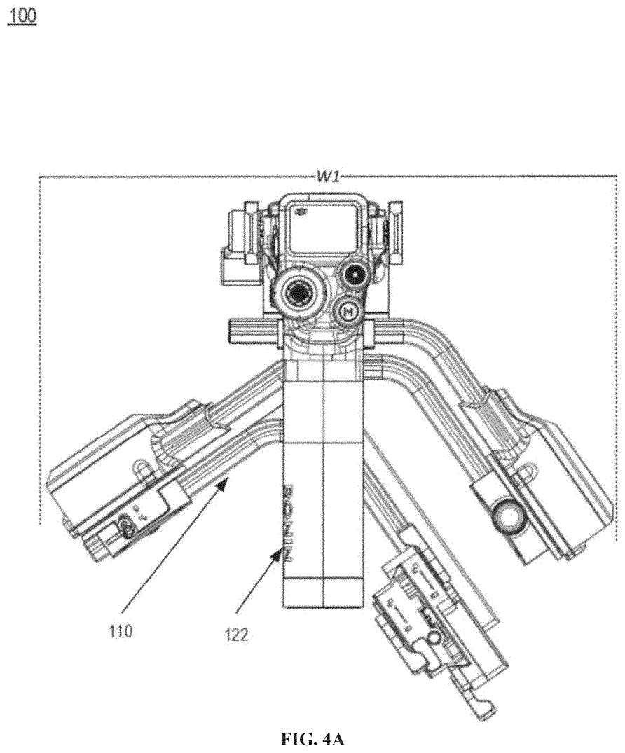

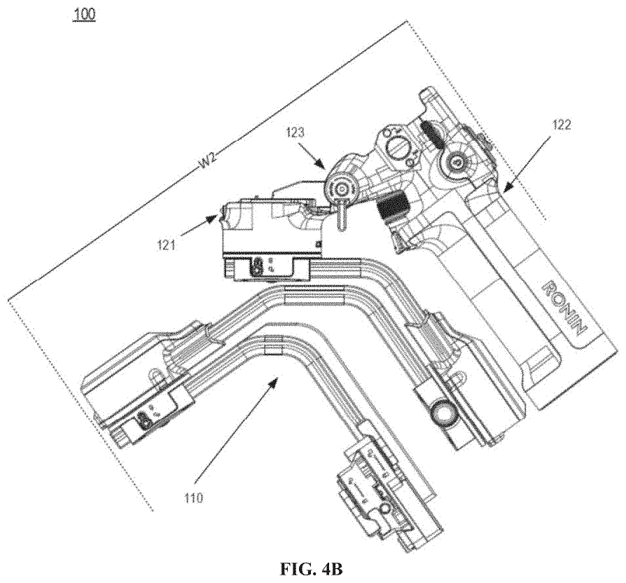

In some embodiments, body 110 may be configured to be inoperative when handle assembly 120 (and/or handheld gimbal 100) is in a particular configuration (e.g., the storage configurations illustrated in FIGS. 4A and 4B). For example, one or more electronic components of handheld gimbal 100 (e.g., one or more axis motors, control assembly 740, communications part, etc.) may be shut down when the particular configuration is detected. In some embodiments, when the gimbal in the storage configurations, the gimbal can be powered on or off.

In some embodiments, body 110 may be configured to be operational during a transition of handle assembly 120 from the first configuration to the second configuration. During the transition, the gimbal assembly 110 and the handle assembly 120 are in electrical connection. In some embodiments, when the gimbal 100 is in operation, the gimbal assembly 110 and the handle assembly 120 may be configured to be operational based on the input signal from a user. For example, when a user presses a button on the handle part, the first part 121 of the handle assembly 120 is configured to move with respect to the second part 122 of the handle assembly, and the gimbal assembly 110 is configured to move the platform to a target attitude.

As described elsewhere in this disclosure, second part 122 may be configured to movable with respect to first part 121, and handle assembly 120 may include two or more configurations. In some configurations of the handle assembly 120, the gimbal is powered on (e.g. at the first and second operational configurations as described elsewhere in the disclosure), and in some other configurations of handle assembly 120, the gimbal is shut down/powered off (e.g. at the storage configuration). For example, second part 122 may be configured to movable with respect to first part 121 between a first configuration (e.g., the folded configuration or a first unfolded configuration) and a second configuration (e.g., an unfolded configuration or a second unfolded configuration). In the first configuration, first part 121 may be at a first position relative to second part 122. In the second configuration, first part 121 is at a second position relative to second part 122, which is different from the first position. Alternatively or additionally, in the first configuration, at least one portion of the first part may overlap with at least one portion of the second part, and in the second configuration, at least one portion of the first part may be spaced apart from at least one portion of the second part.

Control assembly 740 may be configured to control body 110 according to a first control mechanism when handle assembly 120 is in a first configuration and to control body 110 according to a second control mechanism when handle assembly 120 is in a second configuration. A control mechanism may include a hardware component for controlling the gimbal assembly, a control signal or instruction for controlling the gimbal assembly, an algorithm for controlling the gimbal assembly, or a combination thereof. For example, the first configuration may be an unfolded configuration, and the second configuration may be the folded configuration. When handle assembly 120 is in the folded configuration, control assembly 740 may control one or more axis assemblies to move according a first control mode (e.g., controlling the one or more axis assemblies based on a target attitude/joint angle). When handle assembly 120 is in an unfolded configuration, control assembly 740 may control one or more axis assemblies to move according a second control mode (e.g., controlling at least one of the axis assemblies based on another attitude/target joint angle). In some embodiments, the first control mechanism includes a first algorithm for controlling body 110, and the second control mechanism includes a second algorithm for controlling body 110. The first algorithm is different from the second algorithm. Alternatively or additionally, when handle assembly 120 is in an unfolded configuration, control assembly 740 may control one or more axis assemblies based on a first mapping of the inputs received via input device 130 and the functions of handheld gimbal 100, and when handle assembly 120 is in the folded configuration, control assembly 740 may control one or more axis assemblies based on a second mapping of the inputs received via input device 130 and the functions of handheld gimbal 100. For example, when handle assembly 120 is in a first configuration, the user may push a joystick (i.e., part of input device 130) in a first direction, and control assembly 740 may control a first axis assembly to move or rotate in a particular direction accordingly. When handle assembly 120 is in a second configuration and when the user pushes the joystick (i.e., part of input device 130) in the same direction, and control assembly 740 may control a second axis assembly (instead of the first axis assembly) to move or rotate in a particular direction. As another example, when handle assembly 120 is in the second configuration and when the user pushes the joystick (i.e., part of input device 130) in the same direction, and control assembly 740 may control the first axis assembly to move or rotate in a direction different from that in the first configuration. In some embodiments, the user may customize a control mechanism (or control model) in a particular configuration. For example, the user may input commands via input device 130 to customize the mapping of inputs through buttons and/or joystick(s) with desired functions of handheld gimbal 100. In some embodiments, control assembly 740 is configured to control body 110 according to a third control mechanism during the transition of handle assembly 120 from the first configuration to the second configuration or from the second configuration to the first configuration. The third control mechanism may be different from the first control mechanism and/or the second control mechanism.

In some embodiments, control assembly 740 is configured to detect a change from a first configuration to a second configuration or from the second configuration to the first configuration. Control assembly 740 may also be configured to control body 110 based on the detected change as described elsewhere in this disclosure.

In some embodiments, the handle assembly includes a rotating mechanism configured to rotate the first part relative to the second part (or the second part relative to the first part) along two or more axes (e.g., the pitch and roll axes). For example, the handle assembly may include a universal joint coupling the first part and the second part of the handle assembly. The universal joint may be configured to rotate the first part (or the second part) relative to the second part (or the first part) along two or more axes.

In some embodiments, the handle assembly (or the handheld gimbal) includes one or more sensors configured to detect at least one of the angles along the two or more axes. For example, the first part and/or the second part may include an inertial measurement unit (IMU) configured to measure data relating to the attitude and acceleration of the respective part of the handle assembly. Alternatively or additionally, the rotating mechanism coupling the first part and the second part may include an axis motor configured to rotate one of the first part and the second part relative to the other part along the rotating axis. The axis motor may be configured to include an angle sensor to measure the joint angle of the axis motor, which is equal to the angle between the first part and the second part along the rotating axis. Alternatively or additionally, the handle assembly may include a distance sensor (e.g., a laser distance meter) configured to measure the distance between at least one portion of the first part and at least one portion of the second part. In some embodiments, control assembly 740 of the handheld gimbal is configured to receive the measured data and determine the angle(s) based on the measured data. Control assembly 740 may also be configured to receive the data relating to the detected angle(s) and determine the configuration of the handle assembly based on the detected angle(s).

In some embodiments, first part 121 and/or second part 122 may move or rotate relative to body 110 along an axis of a second rotating mechanism coupled to body 110 and first part 121. For example, the user may rotate first part 121 and/or second part 122 relative to body 110 for packing and/or storing the handheld gimbal. By way of example, FIGS. 4A and 4B illustrate two storage modes of handheld gimbal 100. In a first storage mode illustrated in FIG. 4A, body 110 is folded into a compact mode for storage when handheld gimbal 100 is not in use. Handle assembly 120 is in another unfolded configuration in which second part 122 is rotated on the top of body 110 along an axis of a second rotating mechanism coupling first part 121 and body 110. In this storage mode, handheld gimbal 100 has a minimum width (labeled as W1 in FIG. 4A), and second part 122 is in a same plane as the arms of the one or more axis assemblies. FIG. 4B illustrates a second storage mode (or configuration) in which second part 122 is rotated to one side of body 110 along the axis of second rotating mechanism 123. In this storage mode, handheld gimbal 100 has a width (labeled as W2 in FIG. 4B) greater than that of the storage mode illustrated in FIG. 4A, but may have a depth less than that of the storage mode illustrated in FIG. 4A. Second part 122 is in a different plane than the arms of the one or more axis assemblies. For example, a plane of second part 122 may be perpendicular to a plane of the arms of the one or more assemblies. These two storage modes provide more flexibility for the user for packing or storing handheld gimbal 100.

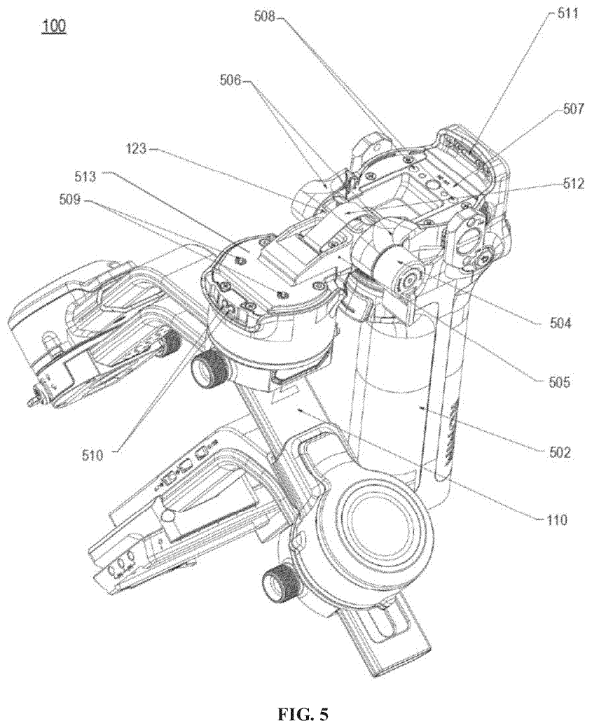

FIG. 5 illustrates a perspective view of handheld gimbal 100 when handle assembly 120 is in an unfolded configuration. Handle assembly 120 includes a handle part 502 for the user to hold during operation. In some embodiments, handle part 502 includes a battery to power handheld gimbal 100 (e.g., yaw axis motor 111, roll axis motor 113, pitch axis motor 115, etc.). As described elsewhere in this disclosure, second part 122 of handle assembly 120 is rotatable along the axis of rotating mechanism 123 with respect to first part 121. Handle assembly 120 includes a knob 504 configured to lock or unlock rotating mechanism 123, thereby locking or unlocking the position of second part 122 relative to first part 121. For example, the user may turn knob 504 clockwise to lock the position of second part 122 and counter-clockwise to unlock the position of second part 122.

Handle assembly 120 includes a rotating mechanism support base 505 for supporting rotating mechanism 123 and connecting first part 121 and second part 122. In some embodiments, rotating mechanism support base 505 may be fixed to first part 121 via screws and/or other fixation means (e.g., glue). Handle assembly 120 also includes two side covers 506 for supporting handle assembly 120 and connecting other components of handle assembly 120.

Second part 122 includes a cover 507. Cover 507 may include one or more receiving parts (e.g., one or more screw holes, positioning holes, etc.) for receiving and connecting an accessory attached to handheld gimbal 100 when handle assembly 120 is in an unfolded configuration (e.g., an underslung mode). For example, the user may attach a bracket for holding a mobile device to handheld gimbal 100 via the receiving part(s) so that the user can operate the mobile device while holding handheld gimbal 100.

First part 121 includes cover 513, the surface of which is supplementary to the surface of cover 507 of second part 122. In some embodiments, when handle assembly 120 is in the folded configuration, there may be little space between cover 513 and cover 507. In some other embodiments, when handle assembly 120 is in the folded configuration, the cover 513 closely matches the cover 507. In some embodiments, cover 507 may also include one or more pins 508, and cover 513 may include one or more pins 509 that correspond to the pin(s) 508. When handle assembly 120 is in a folded configuration, at least one of the one or more pins 509 may be in contact with one of pins 508. In some embodiments, when the handle assembly is in the folded configuration, at least one of the one or more pins 509 can be electrically connected to at least one of pins 508. In some embodiments, the one or more pins 508 include at least one metal pin. Alternatively or additionally, the one or more pins 509 include at least one pin that is retractable. In some embodiments, the retractable pin includes a pogo pin.

In some embodiments, control assembly 740 of handheld gimbal 100 is configured to determine whether handle assembly 120 is in a particular configuration (e.g., the folded configuration, an unfolded configuration). For example, control assembly 740 is configured to monitor whether the at least one of the one or more pins 509 is in contact with one of pins 508 to determine whether handle assembly 120 is in the folded configuration. For example, control assembly 740 may be configured to monitor the electrical connection between the one or more pins 509 and the one or more pins 508. If a connection is detected, control assembly 740 is configured to determine that the handle assembly 120 is in the folded configuration. On the other hand, if no connection (or a disconnection) is detected, control assembly 740 is configured to determine that the handle assembly 120 is in an unfolded configuration. Control assembly 740 may also be configured to take one or more actions in response to the detection of a configuration change of handle assembly 120. For example, control assembly 740 may be configured to determine a target joint angle of one or more motors of the gimbal assembly, in response to a detection that handle assembly 120 is unfolded by the user (or by control assembly 740) and control one or more axis assemblies to move fastening assembly 117 to a attitude/position in which the target joint angle is reached, as described elsewhere in this disclosure. One skilled in the art will now understand that other means for detecting the folding configuration of handle assembly 120 may also be possible. For example, as an alternative or additional means of detecting of the contact of pin 509 and pin 508, handle assembly 120 may include a detection mechanism configured to detect a change of a folding status of handle assembly 120. By way of example, as illustrated in FIG. 5, handle assembly 120 include a sensor 514 implemented in first part 121 (which may be implemented in second part 122 or both first part 121 and second part 122) configured to monitor whether handle assembly 120 is in the folded configuration or an unfolded configuration. Sensor 514 may be configured to detect light (e.g., ambient light or light emitted from a light emitter of sensor 514). Control assembly 740 may receive data from sensor 514 and determine whether handle assembly 120 is in a folded configuration or an unfolded configuration. In some embodiments, sensor 514 includes a photoelectric sensor, an ambient light sensor, a laser distance meter, or the like, or a combination thereof. For example, sensor 514 may include a photoelectric switch, which includes a light transmitter located in one of the first part or the second part, and a light receiver located in the other one of the first part and the second part. Control assembly 740 may be configured to determine a folding state of handle assembly 120 based on the signal received from the photoelectric switch.

In some embodiments, first part 121 includes one or more plungers 510. When handle assembly 120 is in the folded configuration, the one or more plungers 510 are in contact with protection cover 511 of second part 122. A part of each of the one or more plungers 510 may be retracted into protection cover 511, which helps the user to determine whether handle assembly 120 is folded. In some embodiments, when the part of each of the one or more plungers 510 is retracted into protection cover 511, a sound (e.g., a “click” sound) may be produced, which provides a notification to the user that handle assembly 120 is folded. Alternatively or additionally, the handle assembly may include a first magnetic plate in the first part and a second magnetic plate in the second part such that, when the handle assembly is in the folded configuration, the first magnetic plate is in contact with the second magnetic plate. The user may feel the magnetic force when the handle assembly is folded or unfolded. In some embodiments, the one or more plungers 510 may be disposed at the rotating mechanism 123. In this case, the user is able to sense that the predetermined rotating angle is reached.

In some embodiments, handle assembly 120 (or handheld gimbal 100) includes an indicator generating a signal indicating a detected change in the configuration of handle assembly 120. For example, control assembly 740 may detect a configuration change of handle assembly 120 from a first configuration (e.g., the folded configuration or an unfolded configuration) to a second configuration (e.g., an unfolded configuration or the folded configuration). Control assembly 740 may also generate (or cause an indicator to generate) a signal indicating the detected change. By way of example, control assembly 740 may cause a light to generate a light signal or a speaker configured to generate a sound signal, indicating the detected change.

In some embodiments, handle assembly 120 includes a wire 512 connecting at least one electronic component of handle assembly 120 to at least one electronic component of body 110. For example, wire 512 may connect a battery disposed in second part 122 to one or more electronic components of body 110 (e.g., one or more axis motors). In some embodiments, wire 512 may connect the electronic components of handle assembly 120 and body 110 regardless of the folding configuration of handle assembly 120. At least one portion of wire 512 may be covered by a protective film or soft rubber to improve the lifetime of wire 512. First part 121 and second part 122 each include a pressing member (e.g., a metal pressing plate) on the top of each end of the portion of wire 512 that is exposed when handle assembly 120 is in an unfolded configuration. The pressing members limit the folding direction that wire 512 is folded when handle assembly 120 is folded. For example, the first part includes a first pressing member for pressing a first portion of wire 512 that comes out of the first part, and the second part includes a second pressing member for pressing a second portion of wire 512 that comes out of the second part.

In some embodiments, wire 512 is folded into a cavity of second part 122 when handle assembly 120 is in the folded configuration. Alternatively or additionally, at least one portion of the wire is located outside of handle assembly 120 when handle assembly 120 is in the folded configuration. In some embodiments, at least one portion of wire 512 is retractable. For example, the retractable portion of wire 512 winds around the axis of the rotating mechanism coupling the first part and the second part.

In some embodiments, wire 512 includes one or more communications cables for transmitting communications signals between the electronic components of the first part, the second part, and/or the gimbal assembly. For example, wire 512 may include a serial cable configured to transmit a serial communication signal. Alternatively or additionally, wire 512 may be configured to transmit a signal generated by a Hall sensor disposed in the gimbal assembly (or the handle assembly). Alternatively or additionally, wire 512 may be configured to transmit a detection signal for detecting a change in a folding status of handle assembly 120. Alternatively or additionally, wire 512 may be configured to transmit a control signal for controlling at least one of the one or more axis assemblies. By way of example, wire 512 may be configured to transmit a control signal for controlling the motor of the yaw axis assembly (i.e., one of the one or more axis assemblies).

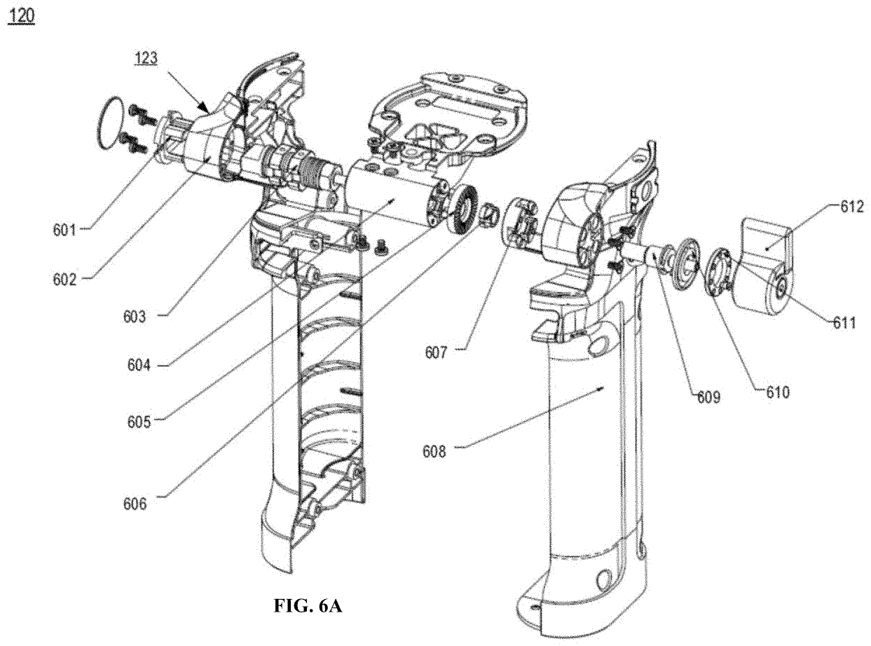

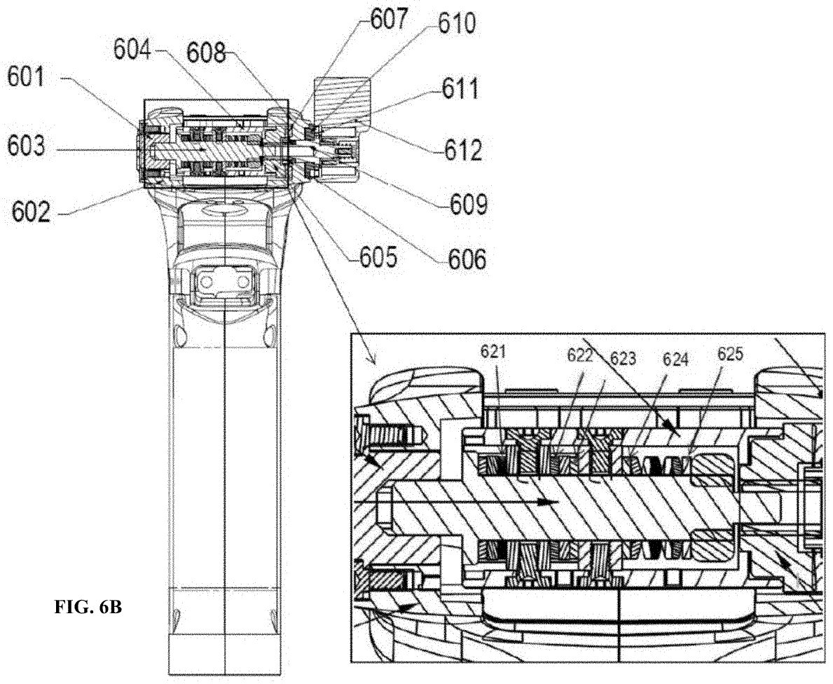

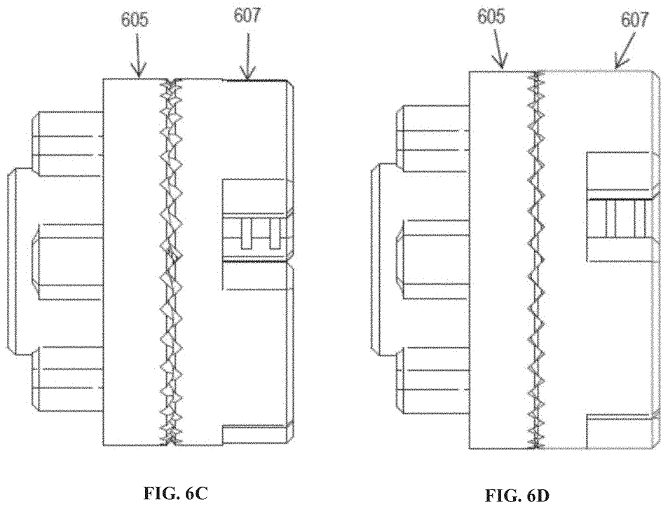

FIGS. 6A and 6B respectively illustrate an exploded view and a front view of an exemplary rotating mechanism 123 consistent with disclosed embodiments. As illustrated in FIG. 6A, handle assembly 120 includes rotating mechanism 123 coupled to the first part and the second part of handle assembly 120. In some embodiments, rotating mechanism 123 may include a damping member (e.g., a damping hinge).

Rotating mechanism 123 includes a front support 601 connected to a right side cover 602 of a first part of the handle assembly (or the handle part of handle assembly). Front support 601 provides support to rotating mechanism 123 and limits the rotation of an axle 603 of rotating mechanism 123. In some embodiments, front support 601 may be fixed to right side cover 602 via screws and/or other fixation means (e.g., glue).

In some embodiments, axle 603 includes a damping axle, which includes two groups of positioning parts configured to connect to an axle support base 604, which is configured to provide support to front gear 605 and connect body 110 and rotating mechanism 123. Axle 603 may also include a damping part, which provide damping and slows down a rotation of axle 603 when axle 603 rotates. For example, as illustrated in FIG. 6B, axle 603 includes a plurality of friction plates 621, 622, 623, 624, and 625. In some embodiments, the damping force exceeds a predetermined value. In some embodiments, the predetermined value is 40 kg·N·m. The front end of axle 603 may have a minimal gap relative to front support 601 such that an axial rotation of the axle is prevented during a lateral movement of axle 603. The rotation of handle assembly 120 and potential mismatch between two immediately connected rotatory components (e.g., front gear 605 and back gear 607) may be decreased or eliminated in the locked state, so that handle assembly 120 does not waggle or shake in the locked state.

Rotating mechanism 123 also includes a front gear 605, which is fixed to axle support base 604 via, for example, glue. Rotating mechanism 123 furthers include a back gear 607 fixed to a left side cover 608 via screws and/or other fixation means (e.g., glue).

In some embodiments, front gear 605 and/or back gear 607 may include a face gear having a plurality of cogs configured to lock the cogs of another face gear when rotating mechanism 123 is tightened, thereby decreasing a lateral movement of axle 603. By way of example, FIGS. 6C and 6D illustrate exemplary cogs of front gear 605 and back gear 607, which are configured to lock the cogs of another face gear when rotating mechanism 123 is tightened. In some embodiments, the number of the cogs of front gear 605 may be the same as that of the cogs of back gear 607. Additionally, the cogs of front gear 605 and the cogs of back gear 607 may be offset by a predetermined angle (e.g., 1°, 2°, 3°, 4°, 5°, etc.), to decrease and/or minimize empty space between first part 121 and the second part 122 when a user locks rotating mechanism 123 before handle assembly 120 is completely folded.

Referring to FIG. 6A, rotating mechanism 123 includes a knob 612 (which may be similar to knob 504 illustrated in FIG. 5), connected to knob axle 609. Knob axle 609 is connected to front gear 605 via, for example, threads in the front end of knob axle 609. When knob 612 is turned (e.g., clockwise or counter-clockwise) by the user, knob 612 is configured to tighten (or loosen) axle 603 such that axle 603 is locked at the current position (or released from the current position). For example, the user may fold handle assembly 120 by rotating first part 121 along the axis of rotating mechanism 123 towards second part 122 until handle assembly 120 is completely folded. The user may turn knob 612 by a certain number of degrees, to cause front gear 605 to rotate and tighten rotating mechanism 123, so that the gap between body 110 and first part 121 is reduced and/or eliminated during the locking process. While front gear 605 and back gear 607 are described for locking rotating mechanism 123 in this disclosure, one skilled in the art will now understand that other locking means may be used for locking and releasing the rotation of first part 121 (and/or second part 122).

Rotating mechanism 123 also includes a knob axle limiting nut 606 configured to limit or prevent lateral movement of axle 603 (i.e., along the axis of axle 603) when knob 612 is turned to release rotating mechanism 123 (i.e., during the unlocking process). The threads of knob axle limiting nut 606 are connected to front gear 605. When the user turns knob 612 to unlock rotating mechanism 123 by, for example, turning knob 612 counter-clockwise, knob axle limiting nut 606 rotates and causes front gear 605 to move laterally (i.e., along the axis of axle 603), which in turn causes front gear 605 to separate from back gear 607. As a result, rotating mechanism 123 is unlocked, and first part 121 (and/or second part 122) rotates along the axis of rotating mechanism 123.

Rotating mechanism 123 further includes a limiting mechanism (e.g., an axle limiting plate 610 and an axle limiting ring 611), which allows knob 612 to be turned in a predetermined range (e.g., 0 to 180°, 0 to 360°, 0 to 540°, 0 to 720°, or the like). Axle limiting plate 610 and axle limiting ring 611 are configured to prevent front gear 605 from being separated too far from back gear 607, which may cause damage to the connection between right side cover 602 and left side cover 608 or other components of rotating mechanism 123.

In some embodiments, rotating mechanism 123 includes a shaft mechanism configured to provide a first torsion, i.e., a torque, in a first range of a rotation of the shaft mechanism and a second torsion in a second range of the rotation of the shaft mechanism. The first torsion is different from the second torsion, such that the user may feel different torsions when the rotation of rotating mechanism 123 progresses in a direction. Alternatively, rotating mechanism 123 may include a fixed-point rotating shaft.

In some embodiments, rotating mechanism 123 may have a first stable position and a second stable position. When rotating mechanism 123 rotates beyond a predetermined position between the first stable position and the second stable position, rotating mechanism 123 automatically rotates to the first stable position or the second position.

In some embodiments, in the folded and locked position, front gear 605 and back gear 607 match completely, so that no empty space exists between the first part 121 and the second part 122 of the handle assembly 120. In an unfolded and unlocked position, the relatively flat design of front support 601 minimizes empty space between the first part 121 and the second part 122 of the handle assembly 120, which may improve user experience by, for example, reducing the gap visible to the user.

In some embodiments, by turning knob 612, the user can lock the position of second part 122 in relation to first part 121 anywhere between the completely folded configuration (as illustrated in FIG. 1) and a maximum unfolded configuration (i.e., an unfolded position in which an end of second part 122 is allowed to be spaced apart from an end of first part 121 by the maximum distance). For example, as illustrated in FIG. 2, the user may unfold handle assembly 120 and rotate second part 122 with respect to first part 121 along the axis of rotating mechanism 123 at a first position. The user may lock the position of second part 122 in relation to first part 121 by turning knob 612 to tighten rotating mechanism 123. As another example, as illustrated in FIG. 3, the user may rotate second part 122 with respect to first part 121 along the axis of rotating mechanism 123 at a second position, which is different from the first position of second part 122 illustrated in FIG. 3. The user may lock the position of second part 122 in relation to first part 121 by turning knob 612 to tighten rotating mechanism 123.

In some embodiments, a handheld gimbal 100 may include a body 110 including one or more axis assemblies, each of the one or more axis assemblies including an arm and a motor for driving the arm to move around an axis. The handle assembly 120 may include a first part 121, a second part 122, and a rotating mechanism 123 coupling the first part 121 and the second part 122. The first part 121 is coupled to the body 110, and the second part 122 is configured to be separated from the body 110. One of the first part 121 or the second part 122 is rotatable relative to the other of the first part 121 or the second part 122. When the handle assembly 120 is in a first configuration, at least one portion of the first part 121 is spaced apart from at least one portion of the second part 122. When the handle assembly 120 is in a second configuration, the at least one portion of the first part 121 are in contact with the at least one portion of the second part 122. The handheld gimbal 100 also includes a communications part electrically coupling an electrical component of the first part 121 to an electrical component of the second part 122 such that the handheld gimbal 100 is allowed to operate during a transition of the handle assembly 120 from the first configuration to the second configuration or from the second configuration to the first configuration.

In some embodiments, a handheld gimbal 100 may include a body 110. The body 110 includes one or more axis assemblies and a platform for supporting a payload, each of the one or more axis assemblies including an arm and a motor for driving the arm to move around an axis. The handheld gimbal 100 may also include a handle assembly 120. The handle assembly 120 includes a first part 121, a second part 122, and a rotating mechanism 123 coupling the first part 121 and the second part 122. The first part 121 is coupled to the body 110, and the second part 122 is configured to be separated from the body 110. The handle assembly 120 may include a folded status and an unfolded status. The handle assembly 120 also include a communications part electrically coupling an electrical component of the first part 121 to an electrical component of the second part 122. The handheld gimbal 100 may further include at least one processor configured to receive, via the communications part, a signal indicating a change in a folding status of the handle assembly 120 from the folded status to the unfolded status or from the unfolded status to the folded status. The at least one processor is also configured to, in response to the received signal, control the one or more axis assemblies to move the payload to a target attitude/position.

In some embodiments, a handheld gimbal 100 may include a gimbal assembly 110 configured to support a payload and rotate the payload with respect to one or more axes. The handheld gimbal 100 also includes a handle assembly 120 operably coupled to the gimbal assembly 110. The handle assembly 120 may include a first part 121 coupled to the gimbal assembly 110, and a second part 122 movable with respect to the first part 121. The first part 121 has a first surface, and the second part 122 has a second surface. The handle assembly 120 has a first configuration in which the first surface and the second surface form a first angle, and the handle assembly has a second configuration in which the first surface and the second surface form a second angle. The first angle is smaller than the second angle. The gimbal assembly 120 is configured to be operational when the handle assembly 120 is in the first configuration and when the handle assembly 120 is in the second configuration.

In some embodiments, a handheld gimbal 100 may include a gimbal assembly 110 configured to support a payload and rotate the payload with respect to one or more axes. The handheld gimbal 100 may also include a handle assembly 120 operably coupled to the gimbal assembly 110, which includes a first part 121 coupled to the gimbal assembly 110 and a second part 122 movable with respect to the first part 121. The handle assembly 120 has a first configuration and a second configuration. In the first configuration, the first part 121 is at a first position relative to the second part. In the second configuration, the first part 122 is at a second position relative to the second part. The first position being different from the second position. The handheld gimbal 100 may also include a control assembly 740 configured to control the gimbal assembly 110 according to a first control mechanism when the handle assembly 120 is in the first configuration and to control the gimbal assembly 110 according to a second control mechanism when the handle assembly 120 is in the second configuration.

In some embodiments, a gimbal 100 may include a gimbal assembly 110 configured to support a payload and rotate the payload with respect to one or more axes. The gimbal 100 may also include a foldable assembly 120 operably coupled to the gimbal assembly 110. The foldable assembly 120 may include a first part 121 coupled to the gimbal assembly 110 and a second part 122 movable with respect to the first part 121. The foldable assembly 120 has a first configuration in which the first part 121 and the second part 122 form a first angle, and the foldable assembly 120 has a second configuration in which the first part 121 and the second part 122 form a second angle. The first angle is smaller than the second angle. The gimbal assembly 110 is configured to be operational when the foldable assembly 120 is in the first configuration and when the foldable assembly 120 is in the second configuration.

In some embodiments, the foldable assembly may comprise a handle assembly including a handle part for a user to hold the gimbal, and in other embodiments, the foldable assembly may comprise a mounting assembly for mounting the gimbal assembly at a portion of a vehicle, a Unmanned Aerial Vehicle or at a working platform or at the top of a user's head or at the helmet.

In some embodiments, the handle/foldable assembly 120 may include a sensor configured to measure the first angle and the second angle. For example, the sensor may comprise an angle sensor, a distance sensor, a light sensor, a Hall sensor etc. In some embodiments, the first angle and second angle may also be calculated by the measurements of the attitudes of the platform and the handle part via the IMUs disposed at the platform and the handle part, respectively.

In some embodiments, the first angle is equal to 0 degrees. The second angle is greater than 0 degrees. In some embodiments, the second angle is equal to or less than 180 degrees.

In some embodiments, the handle/foldable assembly 120 may include a rotating mechanism 123 coupling the first part and the second part. The rotating mechanism 123 may comprises at least one of a hinged mechanism (e.g. the first part and the second part is hinged connected) or a universal joint mechanism (e.g. the first part and the second part is coupled via a universal joint or a ball joint).

In some embodiments, the second part 122 may move with respect to the first part 121 via at least one of the translation, rotation or the combination of the translation and rotation. For example, a slidable or a retractable mechanism may be configured to achieve the translation between the first part 121 and the second part 122. The first part 121 and the second part 122 may be configured to move with respect to each other for at least one freedom of degree. In some embodiments, the first part 121 and the second part 122 may be configured to move with respect to each other for six freedom of degree.

In some embodiments, the handle assembly includes an input device configured to receive an input. When the handle assembly is in the first configuration, the gimbal assembly is configured to rotate the payload in response to a first input. When the handle assembly is in the second configuration, the gimbal assembly is configured to rotate the payload in response to a second input. In some embodiments, the gimbal assembly is configured to be operational during a transition of the handle assembly from the first configuration to the second configuration.

In some embodiments, a gimbal 100 may include a gimbal assembly 110 configured to support a payload and rotate the payload with respect to one or more axes. The gimbal 100 may also include a foldable assembly 120 operably connected to the gimbal assembly 110, includes a first part 121 coupled to the gimbal assembly 110, and a second part 122 movable with respect to the first part 121 between a first configuration of the foldable assembly 120 and a second configuration of the foldable assembly 120. The gimbal 100 may also include a control assembly 740 configured to control the gimbal assembly 110 according to a first control mechanism when the foldable assembly 120 is in the first configuration and to control the gimbal assembly 110 according to a second control mechanism when the foldable assembly 120 is in the second configuration.

In some embodiments, the control assembly 740 is configured to detect a change from the first configuration to the second configuration or from the second configuration to the first configuration. In response to detecting the change, the control assembly is configured to change the control mechanism from the first control mechanism to the second control mechanism or from the second control mechanism to the first control mechanism.

In some embodiments, in the first configuration, at least one portion of the first part overlaps with at least one portion of the second part. In the second configuration, at least one portion of the first part is spaced apart from at least one portion of the second part. The control assembly is configured to control the gimbal assembly during a transition of the handle assembly from the first configuration to the second configuration or from the second configuration to the first configuration.

For example, in the first configuration, at least one portion of the first part forms a first angle with at least one portion of the second part; in the second configuration, at least one portion of the first part forms a second angle with at least one portion of the second part. The first angle and the second angle are different. Alternatively, assuming the second part of the handle assembly is not moved, in the first configuration, the first part has a first position and a first orientation with respect to the second part; in the second configuration, the first part has a second position and a second orientation with respect to the second part. At least one of the first position and the first orientation is different from at least one of the second position and a second orientation. Alternatively, as described elsewhere in this disclosure, in the first configuration, the first part of the handle assembly is folded (or unfolded) with respect to the second part of the handle assembly; and in the second configuration, the first part of the handle assembly is unfolded (or folded) with respect to the second part of the handle assembly.

In some embodiments, the control assembly is configured to control the gimbal assembly according to a third control mechanism during the transition of the handle assembly from the first configuration to the second configuration or from the second configuration to the first configuration. During the transition, the gimbal is powered on. In some embodiments, the first control mechanism includes a first algorithm for controlling the gimbal assembly, and the second control mechanism includes a second algorithm for controlling the gimbal assembly, and the third control mechanism includes a third algorithm for controlling the gimbal assembly. The first algorithm is different from the second algorithm. The third algorithm is different from the first algorithm and the second algorithm.

In some embodiments, the handle assembly includes an input device configured to receive an input, and the gimbal assembly is configured to rotate the payload or change the control mechanism/algorithm in response to the received input. For example, a user may press a button once on the handle assembly with a first input when the handle assembly in the first configuration, the control assembly is configured to control the gimbal assembly according to the first control mechanism. The user may press the button twice on the handle assembly with a second input when the handle assembly in the second configuration, the control assembly is configured to control the gimbal assembly according to the second control mechanism. For example, the first control mechanism can be configured to allow the platform to a first target attitude, and the second control mechanism can be configured to allow the platform to a second target attitude. The first target attitude and the second target attitude can be the same or be different.

As described elsewhere in the disclosure, the angle between the first part and the second part of the handle assembly may be measured via a sensor. In some embodiments, the angle(s) can also be predetermined for a set of values, such as 0, 30 degree, 60 degree, 90 degree, 120 degree etc. For example, an angle scale is disposed at the rotating mechanism 123, and thus, the user can read the actual angle via the scale or unfolds the handle assembly to a desired angle. A skilled person in the art would understand other display devices may be possible rather than an angle scale. Alternatively, a plunger mechanism may be disposed at the rotating mechanism such that signals can be sent to the control assembly/a user to indicate the predetermined angle is reached. The signal may be light or sound etc.

In some embodiments, the first configuration is associated with a first mode of the gimbal including the first angle and the first control mechanism/algorithm, and the second configuration is associated with a second mode of the gimbal including the second angle and the second control mechanism/algorithm. In some embodiments, the first mode or the second mode can be one of a handheld mode, an inversed mode, a carry/underslung mode, a flashlight mode, a portrait mode or a storage mode. For example, in the handheld mode, the handle assembly may be folded/closed and a user can hold the handle part of the handle assembly in a normal operational mode/a vertical plane; in the inversed mode, the handle assembly may be folded/closed and the handle part is inversed compared to in the normal operational mode; in the carry/underslung mode, the handle assembly may be unfolded and the handle part is parallel to the horizontal plane; in the flashlight mode, the handle assembly may be folded/closed and the handle part is parallel to the horizontal plane; in the portrait mode, the camera is disposed perpendicular to the horizontal plane; in the storage mode, the gimbal may be configured to a configuration to occupy a relatively less space, such as shown in FIGS. 4A and 4B.

In some embodiments, when the handle assembly switches the configuration, the control mechanism/algorithm/mode of the gimbal is configured to change. The control mechanism/algorithm/mode may comprise the control mechanism/algorithm to change the attitude of the platform of the gimbal, or the control mechanism/algorithm to change the user defied mode, or other control mechanism/algorithm associated with the operation of the gimbal or at least one of the handheld mode, the inversed mode, the carry/underslung mode, the flashlight mode, the portrait mode or the storage mode.

In some embodiments, there exists a gimbal lock (or for other reasons), which may occur when one of axes (the middle axis e.g., roll axis in the yaw-roll-pitch axis configuration) approaches 90 or −90 degrees (which is also referred as a singularity). Existing handheld gimbals generally use a non-orthogonal ZXY configuration of the three axis assemblies, and existing methods for controlling the three axis assemblies generally use algorithms based on feedback of the attitude involving all three axes. When the joint angle approaches the singularity, the Jacobian matrix between the joint angle speed and the body angular speed of the payload becomes non-deficient, therefore the calculated desired speed of one or more axis arms may become infinite. The control assembly 740 may be configured to control one or more axis assemblies according to a joint angle control mode. In some embodiments, the joint angle is the angle that the rotor of a motor rotates around the stator of the motor. For example, control assembly 740 may determine a target joint angle of the yaw motor and control the yaw assembly according to a joint angle control mode such that the target joint angle of the yaw motor is reached. In some embodiments, in a joint angle control mode, control assembly 740 is configured to control an axis motor to rotate to a target joint angle. If control assembly 740 controls two or more axis motors in the joint angle control mode, control assembly 740 may be configured to control the axis motors individually. For example, control assembly 740 controls a first axis motor to move to the target joint angle of the first axis motor and controls a second axis motor to move to the target joint angle of the second axis motor. In some embodiments, control assembly 740 is configured to control an axis assembly in the joint angle control mode and control one or more axis assemblies in an attitude angle control mode. In an attitude angle control mode, control assembly 740 is configured to control an axis assembly such that a target attitude angle of the axis assembly (determined in the NED-coordinate system) is reached. An attitude angle of an axis assembly under the north-east-down (NED) coordinate system may be determined based on the target joint angle (the calculation of which is described below) and a conversion algorithm. In some embodiments, the conversion algorithm can transform rotation matrix to attitude quaternions.

In some embodiments, a target joint angle of an axis motor may be determined based on the following equations. The quaternions of the target attitude of photographic device 118 are assumed as a q_{camera}ⁿ, where n is a north-east-down (NED) coordinate system and camera is the payload-coordinate system. The quaternions of the attitude of handle assembly 120 are assumed as q_{base}ⁿ, where n is the north-east-down (NED) coordinate system and base is the handle coordinate system. In some embodiments, different payload attitude angles may be achieved, without moving the position of handle assembly 120, by setting different joint angles. Accordingly, it can be assumed:

q_{camera}ⁿ=q_{base}ⁿq_{camera}^{base} (1)

, where q_{camera}^{base} are conversion quaternions.

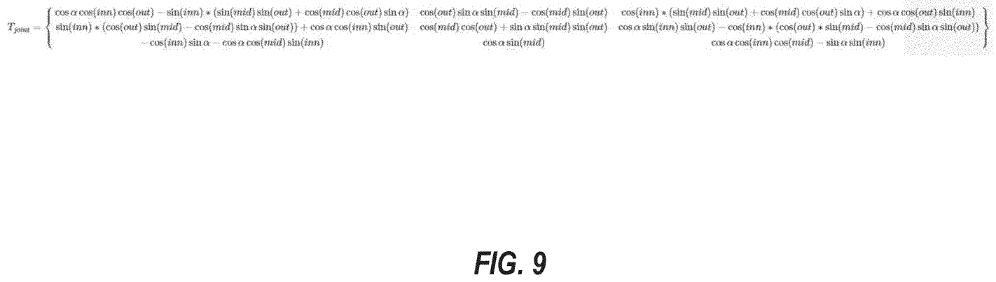

q_{camera}^{base} is converted to a matrix T. Tⱼₒᵢₙₜ can be obtained by combining the three equations (3)-(5) below:

$$\begin{matrix}{T}_{j o i n t} = {R}_{z} {R}_{x *} {R}_{y} , & ( 2 ) \\ {R}_{z} = \{ \begin{matrix}cos ( out ) & - s in ( out ) & 0 \\ sin ( out ) & cos ( out ) & 0 \\ 0 & 0 & 1\end{matrix} \} , & ( 3 ) \\ {R}_{x *} = \{ \begin{matrix}cos ( α ) & 0 & sin ( α ) \\ 0 & 1 & 0 \\ - s in ( α ) & 0 & cos ( α )\end{matrix} \} \{ \begin{matrix}1 & 0 & 0 \\ 0 & cos ( mid ) & - s in ( mid ) \\ 0 & sin ( mid ) & cos ( mid )\end{matrix} \} , & ( 4 ) \\ {R}_{y} = \{ \begin{matrix}cos ( inn ) & 0 & sin ( inn ) \\ 0 & 1 & 0 \\ - s in ( inn ) & 0 & cos ( inn )\end{matrix} \} , & ( 5 )\end{matrix}$$

where a is the angle (shown in FIG. 1), which is the angle from a horizontal plane (or plane crossing platform 117-1) to the axis of roll axis motor 113 (generally a negative angle). In the embodiments of the orthogonal configuration of the three axis assemblies, a equals zero. As described elsewhere in this disclosure, the a angle may be measured by an angle sensor or preset. The combination of equations (3)-(5) as equation (6) is shown in FIG. 9.

The target joint angles inn, out, and mid in equations (3)-(5) correspond to the target joint angle of the inner axis (i.e., the axis closest to the payload), the target joint angle of the outer axis (i.e., the axis furthest away from the payload), and the target joint angle of the axis in the middle. The current and target joint angles inn, out, and mid can be solved as follows:

$$\begin{matrix}mid = arctan 2 \frac{{T}_{32}}{\pm \sqrt{{T}_{31}^{2} + {T}_{33}^{2} - sin α}} , & ( 7 ) \\ inn = arctan 2 ( \frac{- {T}_{31} cos ( α ) cos ( mid ) - {T}_{33} sin ( α )}{{T}_{33} cos ( α ) cos ( mid ) - {T}_{31} sin ( α )} ) + α , & ( 8 ) \\ out = arctan 2 ( \frac{{T}_{22} sin ( α ) sin ( mid ) - {T}_{12} cos ( mid )}{{T}_{12} sin ( α ) sin ( mid ) + {T}_{22} cos ( mid )} ) , & ( 9 )\end{matrix}$$

The current and target joint angles inn, out, and mid in equations (7)-(9) can have two sets of solutions, and one set includes inn(current), out(current), and mid(current) and the other set includes inn(target), out(target), and mid(target). The current set of inn, out, mid joint angles can be measured via a sensor, and thus, the person skilled in the art would obtain the other set of the target joint angles inn, out, mid. It can be deduced from the analysis of the current and target joint angles that, to switch from the folded configuration to an unfolded configuration (or vice versa), the joint angle passes −90 degrees (or 90 degrees), and a singularity may occur. Existing handheld gimbals generally use a non-orthogonal ZXY configuration of the three axis assemblies, and existing methods for controlling the three axis assemblies generally use algorithms based on feedback of the attitude involving all three axes. Such methods may not work for switching one folding configuration to another folding configuration because when the joint angle reaches the singularity point, the calculated speed of one or more axis arms may become infinite.

The methods described in this disclosure separately control the yaw axis assembly such that a target joint angle is reached, and control the pitch axis assembly and the roll axis assembly such that the target attitude angles of the control the pitch axis assembly and the roll axis assembly are reached. For example, control assembly 740 may determine the target joint angle of the yaw axis. Control assembly 740 may also cause the yaw axis assembly to move photographic device 118 to an attitude/position (and/or orientation) at which the target joint angle is reached. Control assembly 740 may further determine target attitude angles of the pitch axis assembly and the roll axis assembly, and cause the pitch axis assembly and the roll axis assembly to move photographic device 118 to an attitude/position (and/or orientation) at which the target attitude angles are also reached.

In some embodiments, control assembly 740 determines whether the target joint angle of an axis motor is in a predetermined range. The predetermined range may be a limiting range of the joint angle. For example, the predetermined range may be [−255°, 100° ], [−245°, 90° ], [−235°, 80° ], [−225°, 70° ], or [−215°, 60° ], or the like. By way of example, assuming that the predetermined range is [−215°, 60° ], if control assembly 740 determines the target joint angle of an axis motor is −100° (as described elsewhere in this disclosure), control assembly 740 determines that the target joint angle is within the predetermined range. In some embodiments, if control assembly 740 determines that the target joint angle is out of the predetermined range, control assembly 740 causes one or more axis assemblies to move photograph device 118 to a reset position. For example, control assembly 740 may cause one or more axis assemblies to move photographic device 118 to a reset attitude, at which photographic device 118 is at a horizontal level in the pitch and roll axes (e.g., 0 pitch degree and 0 roll degree) and the orientation of photographic device 118 is the same as the orientation of the base of handheld gimbal 100 in the yaw axis (e.g., same yaw degree). Control assembly 740 is also configured to determine the current joint angle at the reset attitude and determine an updated target joint angle, as described elsewhere in this disclosure. Control assembly 740 is further configured to determine whether the updated target joint angle is within the predetermined range.

If control assembly 740 determines that the target joint angle is within the predetermined range, control assembly 740 controls the one or more axis assemblies to move to a target attitude/position such that the target angle is reached. For example, as described elsewhere in this disclosure, control assembly 740 transmits instructions and data relating to the target joint angle to controller 731. Controller 731 is configured to receive data relating to the current joint angle received from angle sensor 733 (or control assembly 740). Angle sensor 733 is configured to measure the joint angle of the motor of the yaw axis. Controller 731 is configured to control yaw axis motor 111 to drive yaw axis arm 112 based on the current joint angle and the target joint angle. By continuously (or intermittently) monitoring the current joint angle, controller 731 is configured to control yaw axis motor 111 to drive yaw axis arm 112 to reach the target joint angle by determining the difference between the current joint angle and the target joint angle and drive yaw axis arm 111 to reach the target joint angle based on the difference.

In some embodiments, control assembly 740 is configured to determine a trajectory of photographic device 118 (and/or roll axis arm 114) to the attitude/position (and/or orientation) at which the target joint angle is reached, based on the current joint angle, the target joint angle and the total time for completing the transition between a first configuration and a second configuration of the gimbal. For example, control assembly 740 determines an S-shaped velocity curve based on the current joint angle, the target joint angle and the total time for completing the transition between a first configuration and a second configuration of the gimbal. Control assembly 740 is also configured to cause roll/yaw/pitch axis arm 112/114/116 to move along the determined trajectory such that the target joint angle(s) is/are reached. Based on the S-shaped velocity curve, the target first joint angle or the target second joint angle or the target third joint angle at predetermined intervals from a starting point can be determined. The target first joint angle or the target second joint angle or the target third joint angle at each moment from a starting point can be determined.

In some embodiments, control assembly 740 is configured to determine one or more (or two or more) intermediate positions of photographic device 118 (and/or roll axis arm 114) between the current position and the target position (at which the target joint angle is reached). For example, based on the trajectory of photographic device 118 described elsewhere in the disclosure. Control assembly 740 is also configured to cause yaw/roll/pitch axis arm 112/114/116 to move photographic device 118 (and/or roll axis arm 114) to the one or more intermediate positions and the target position sequentially. In some embodiments, for each of the one or more intermediate positions, control assembly 740 determines at least one of an intermediate pitch angle, an intermediate roll angle, and an intermediate yaw angle.

In some embodiments, control assembly 740 determines an updated current joint angle (and/or a current attitude angle) when one or more axis assemblies move to another position. Control assembly 740 is also configured to determine that the difference between the updated current joint angle (and/or the current attitude angle) and the target joint angle (the target attitude angle) is equal to or less than a threshold. The threshold may be in a range of 0.01 to 1 degree. In some embodiments, the threshold may be limited to subranges of 0.01 to 0.05 degrees, 0.05 to 0.1 degrees, 0.1 to 0.5 degrees, 0.5 to 1 degree, or the like. If control assembly 740 determines that the difference is less than the threshold, control assembly 740 confirms that a change from a first configuration (e.g., handle assembly 120 is in the folded configuration) to a second configuration (e.g., handle assembly 120 is in an unfolded configuration) is completed. In some embodiments, control assembly 740 is configured to cause an output device to provide a confirmation that the change is completed. For example, handheld gimbal 100 may include an output device, such as a speaker, a screen, a motor, configured to provide a confirmation to the user by producing a sound, an alert on the screen, vibrations, or the like, or a combination thereof, via the output device. Alternatively or additionally, handheld gimbal 100 may transmit a confirmation message to a terminal associated with the user (e.g., a mobile device), indicating that the change is completed.

FIG. 7 is a block diagram of exemplary handheld gimbal 100 consistent with disclosed embodiments. As described elsewhere in this disclosure, handheld gimbal 100 includes one or more assemblies, including, for example, a pitch axis assembly, a roll axis assembly, and a yaw axis assembly, which may be configured to move fastening assembly 117 (and photographic device 118). Handheld gimbal 100 also includes a control assembly 740 configured to control the axis assemblies to move fastening assembly 117. Handheld gimbal 100 further includes a pitch axis arm 116, a roll axis arm 114, a yaw axis arm 112, and a fastening assembly 117, which are also collectively referred to herein as a gimbal 750. While handheld gimbal 100 illustrated in FIG. 7, includes a pitch-roll-yaw configuration, one skilled in the art would understand that other configurations are also possible (e.g., a yaw-roll-pitch configuration, a pitch-yaw-roll configuration, etc.).

As illustrated in FIG. 7, the yaw axis assembly includes a controller 731, yaw axis motor 111, and an angle sensor 733. Controller 731 is configured to receive instructions from control assembly 740 and control yaw axis motor 111 based on the instructions and sensor data received from angle sensor 733. For example, control assembly 740 may determine a target joint angle of yaw axis motor 111 and transmit data relating to the target joint angle to controller 731. Angle sensor 733 is configured to measure the joint angle of the yaw axis motor. Controller 731 is configured to receive the data relating to the target joint angle from control assembly 740 and the current joint angle from angle sensor 733. Controller 731 is configured to control yaw axis motor 111 to drive yaw axis arm 112 based on the current joint angle and the target joint angle under a joint angle control mode. By continuously (or intermittently) monitoring the current joint angle, which may be subject to change during the movement of gimbal 750, controller 721 is configured to control yaw axis motor 111 to drive yaw axis arm 112 to reach the target joint angle. This is achieved by closed-loop control of the current joint angle by determining the difference between the current joint angle and the target joint angle and controlling yaw axis motor 111 to reach the target joint angle gradually.

The gimbal and/or pitch axis assembly include(s) a controller 711, pitch axis motor 115, a gyroscope 713, and an integrator 714. Controller 711 is configured to receive instructions from control assembly 740 and control pitch axis motor 115 based on the received instructions and sensor data. For example, control assembly 740 may determine a target pitch attitude angle. Control assembly 740 may also be configured to determine a target attitude angle of the pitch axis assembly under a north-east-down (NED) coordinate system based on the target attitude angle. Control assembly 740 may transmit the data relating to the target attitude angle to controller 711 (and transmit the data relating to the target roll angle to controller 721). Controller 711 is also configured to receive data relating to the current attitude angle from integrator 714, which performs an integration operation on an angular velocity outputted by gyroscope 713 to obtain a measured current pitch angle of handheld gimbal 100. Controller 711 is configured to control pitch axis motor 115 and roll axis motor 113 to drive the fastening assembly 117 (and photographic device 118) based on the current pitch angle and the target attitude angle.

The gimbal and/or roll axis assembly include(s) a controller 721, roll axis motor 113, a gyroscope 723, and an integrator 724. In some embodiments, the gyroscope 713 and the gyroscope 723 can be the same and provided at a portion of the arm of the gimbal (e.g. a fastening assembly 117 of the pitch arm 112). Controller 721 is configured to receive instructions from control assembly 740 and control roll axis motor 113 based on the received instructions and sensor data. For example, as described elsewhere in the application, control assembly 740 may determine a target roll attitude angle. Control assembly 740 may determine a target attitude angle of the roll assembly under the north-east-down (NED) coordinate system based on the target attitude angle. Control assembly 740 transmits the data relating to the target roll angle to controller 721. Controller 721 is configured to receive data relating to the current roll angle from integrator 724, which performs an integration operation on an angular velocity outputted by gyroscope 723 to obtain a measured roll angle of handheld gimbal 100. Controller 721 is configured to control roll axis motor 113 and pitch axis motor 115 to drive the fastening assembly 117 (and photographic device 118) based on the current roll angle and the target attitude angle.

By continuously (or intermittently) monitoring the current attitude angles, which may be subject to change during the movement of gimbal 750, controller 711 and controller 721 are configured to control pitch axis motor 115 and roll axis motor 113 to drive pitch axis arm 116 and roll axis arm 114 (the fastening assembly 117/photographic device 118) to achieve the target attitude angles. This achieves closed-loop control of the current attitude angles by determining the difference between the current attitude angles and the target attitude angles, and controlling pitch axis motor 115 and roll axis motor 113 to reach the target attitude angles gradually.

In some embodiments, control assembly 740 causes yaw axis arm 112 and pitch axis arm 116 to move photographic device 118 to a first attitude/position (and/or orientation) such that the target attitude angle is reached, while maintaining the current joint angle (e.g., roll axis arm 114 may remain at rest). After the target attitude angle is reached, control assembly 740 is configured to cause roll axis arm 114 to move photographic device 118 to a second attitude/position (and/or orientation) such that the target joint angle is also reached. In other embodiments, control assembly 740 causes roll axis arm 114 to move photographic device 118 to a first attitude/position (and/or orientation) such that the target joint angle is reached, while maintaining the current attitude angle. After the target joint angle is reached, control assembly 740 is configured to cause yaw axis arm 112 and pitch axis arm 116 to move photographic device 118 to a second attitude/position (and/or orientation) such that the target attitude angle is also reached.

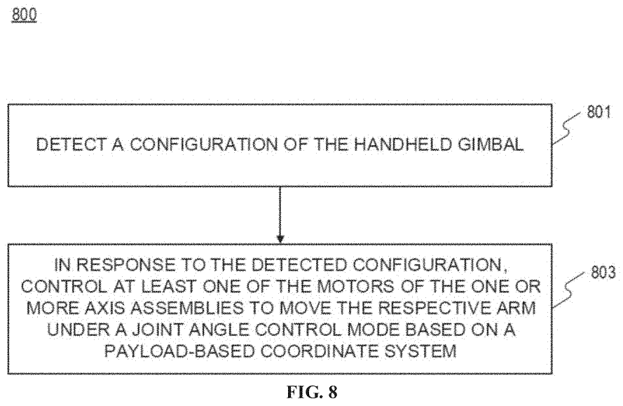

FIG. 8 is a flowchart of an exemplary process 800 for controlling a handheld gimbal. Process 800 may be performed by at least one processor (e.g., control assembly 740) and/or one or more controllers (e.g., controller 711, controller 721, controller 731, etc.) described in this application. While the description of process 800 is provided herein using control assembly 740 as an example, other processor(s) and/or controller(s) may also be configured to one or more steps of process 800 described herein.

At step 801, a configuration of handle assembly 120 may be detected/determined. As described elsewhere in this disclosure, the user may unfold handle assembly 120 from the folded configuration illustrated in FIG. 1 to the unfolded configuration illustrated in FIG. 2, by rotating second part 122 along the axis of rotating mechanism 123. When handle assembly 120 is in the folded configuration, pins 509 and the corresponding pins 508 are in contact with each other, which establishes an electrical connection between at least one pin 509 and pin 508. Control assembly 740 is configured to monitor the contact status (e.g., the connection or disconnection) between pins 509 and the corresponding pins 508. When the user unfolds handle assembly 120, pins 509 and the corresponding pins 508 become disconnected, and control assembly 740 is configured to detect the disconnection and detect that handle assembly 120 is in an unfolded configuration. As another example, when the user folds handle assembly 120, pins 509 and the corresponding pins 508 become connected, and control assembly 740 is configured to detect the connection. Control assembly 740 also detects the configuration (e.g., from the folded configuration to an unfolded configuration, from an unfolded configuration to the folded configuration) based on the detected connection or disconnection between at least one pin 509 and pin 508. Alternatively or additionally, control assembly 740 may be configured to detect/determine a configuration of handle assembly 120 based on other means (e.g., detecting the angle formed by first part 121 and second part 122) as described elsewhere in this disclosure.

At step 803, in response to the detected configuration, control assembly 740 may be configured to control at least one of the motors of the one or more axis assemblies to move the respective arm under a joint angle control mode. For example, as described elsewhere in this disclosure, control assembly 740 may determine a target joint angle of the yaw motor and control the yaw motor to move to the target joint angle. In some embodiments, control assembly 740 may determine an attitude angle under the north-east-down (NED) coordinate system for another axis assembly (for each of the other two assemblies, e.g. roll axis assembly and pitch axis assembly) and move the axis assembly (or axis assemblies, e.g. roll axis assembly and pitch axis assembly) such that the target attitude angle(s) is/are reached.

In some embodiments, a method for controlling a handheld gimbal 100 that comprises a handle assembly 120 includes determining whether the handle assembly 120 is in a first configuration. The handheld gimbal 100 includes a platform supporting a payload and one or more axis assemblies. The one or more axis assemblies includes a first axis assembly. The first axis assembly includes a first arm and a first motor configured to move the first arm around a first axis. The handle assembly is capable of changing between the first configuration and a second configuration different from the first configuration. The method further includes, in response to detecting/determining the handle assembly being in the first configuration, controlling the first axis assembly to move to a first target position under a joint angle control mode for controlling a joint angle of the first motor.

In some embodiments, a handheld gimbal 100 may include a body 110 including one or more axis assemblies. Each of the one or more axis assemblies includes an arm and a motor for driving the arm to move around an axis. The handheld gimbal 100 may also include a control assembly 740 configured to detect a configuration of the handheld gimbal 100, and in response to the detected configuration, control at least one of the motors of the one or more axis assemblies to move the respective arm under a joint angle control mode.

In some embodiments, a method for controlling a handheld gimbal 100 is provided. The handheld gimbal 100 may comprise a foldable assembly 120 and a platform supporting a payload. The handheld gimbal 100 may also comprise one or more axis assemblies, and the one or more axis assemblies comprise a first axis assembly; and the first axis assembly comprises a first arm and a first motor configured to move the first arm around a first axis. The method may include detecting a change in a folding status of the foldable assembly, and in response to the detected change in the folding status, controlling the first axis assembly to move to a first target position under a joint angle control mode for controlling a joint angle of the first motor.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1.-105. (canceled)

106. A handheld gimbal, comprising:
a gimbal assembly configured to support a payload and rotate the payload with respect to one or more axes; and
a handle assembly operably coupled to the gimbal assembly, the handle assembly comprising:
a first part coupled to the gimbal assembly; and
a second part movable with respect to the first part, wherein:
the first part has a first surface,
the second part has a second surface,
the handle assembly has a first configuration in which the first surface and the second surface form a first angle,
the handle assembly has a second configuration in which the first surface and the second surface form a second angle, the first angle being smaller than the second angle, and
the gimbal assembly is configured to be operational when the handle assembly is in the first configuration and when the handle assembly is in the second configuration.

107. The handheld gimbal of claim 106, wherein the handle assembly comprises a sensor configured to measure the first angle and the second angle.

108. The handheld gimbal of claim 106, wherein the first angle is equal to 0 degrees.

109. The handheld gimbal of claim 106, wherein the second angle is greater than 0 degrees.

110. The handheld gimbal of claim 106, wherein the second angle is equal to or less than 180 degrees.

111. The handheld gimbal of claim 106, wherein the handle assembly comprises a rotating mechanism coupling the first part and the second part.

112. The handheld gimbal of claim 106, wherein:
the handle assembly comprises an input device configured to receive an input;
when the handle assembly is in the first configuration, the gimbal assembly is configured to rotate the payload in response to a first input; and
when the handle assembly is in the second configuration, the gimbal assembly is configured to rotate the payload in response to a second input.

113. The handheld gimbal of claim 106, wherein the gimbal assembly is configured to be operational during a transition of the handle assembly from the first configuration to the second configuration.

114. A handheld gimbal, comprising:
a gimbal assembly configured to support a payload and rotate the payload with respect to one or more axes;
a handle assembly operably coupled to the gimbal assembly, comprising:
a first part coupled to the gimbal assembly; and
a second part movable with respect to the first part, wherein:
the handle assembly has a first configuration and a second configuration;
in the first configuration, the first part is at a first position relative to the second part, and
in the second configuration, the first part is at a second position relative to the second part, the first position being different from the second position; and
a control assembly configured to control the gimbal assembly according to a first control mechanism when the handle assembly is in the first configuration and to control the gimbal assembly according to a second control mechanism when the handle assembly is in the second configuration.

115. The handheld gimbal of claim 114, wherein the control assembly is configured to detect a change from the first configuration to the second configuration or from the second configuration to the first configuration.

116. The handheld gimbal of claim 114, wherein in the first configuration, at least one portion of the first part overlaps with at least one portion of the second part.

117. The handheld gimbal of claim 114, wherein in the second configuration, at least one portion of the first part is spaced apart from at least one portion of the second part.

118. The handheld gimbal of claim 114, wherein the control assembly is configured to control the gimbal assembly during a transition of the handle assembly from the first configuration to the second configuration or from the second configuration to the first configuration.

119. The handheld gimbal of claim 118, wherein the control assembly is configured to control the gimbal assembly according to a third control mechanism during the transition of the handle assembly from the first configuration to the second configuration or from the second configuration to the first configuration.

120. The handheld gimbal of claim 114, wherein:
the first control mechanism comprises a first algorithm for controlling the gimbal assembly; and
the second control mechanism comprises a second algorithm for controlling the gimbal assembly, the first algorithm being different from the second algorithm.

121. The handheld gimbal of claim 114, wherein:
the handle assembly comprises an input device configured to receive an input; and
the gimbal assembly is configured to rotate the payload in response to the received input.

122.-130. (canceled)
